(19) United States
(12) Patent Application Publication
(10) Pub. No.: US 2026/0369276 A1
(43) Pub. Date: Nov. 19, 2026

(54) ELECTRONIC DEVICE AND USER UTTERANCE PROCESSING METHOD OF ELECTRONIC DEVICE

(71) Applicant: Samsung Electronics Co., Ltd., Suwon-si, Gyeonggi-do (KR)

(72) Inventors: Changbeom LIM, Suwon-si (KR); Gajin SONG, Suwon-si (KR); Hoseon SHIN, Suwon-si (KR)

(21) Appl. No.: 19/475,619

(22) PCT Filed: Sep. 19, 2023
(86) PCT No.: PCT/KR2023/014177

§ 371 Date: Oct. 15, 2025

(30) Foreign Application Priority Data
Sep. 19, 2022 (KR) 10-2022-0117867
Oct. 31, 2022 (KR) 10-2022-0142832

(51) Int. Cl. G10L 15/30; G10L 15/22

(52) U.S. Cl. CPC G10L 15/30; G10L 15/22

(57) ABSTRACT

An electronic device according to an embodiment disclosed in the present document may comprise a microphone, a speaker, a display, a communication circuit, a memory, and a processor. The memory may store instructions causing, when executed by the processor, the electronic device to receive a user utterance through the microphone, when receiving the user utterance, recognize whether content is being played back through the display or the speaker, if content is being played back, recognize whether there is at least one first external electronic device connected to the electronic device through the communication circuit, on the basis of at least a part of information on the at least one first external electronic device connected to the electronic device and information on at least one second external electronic device registered in a user account, determine whether an environment is a multi-device environment related to a voice assistant service, on the basis of a determination that the environment is a multi-device environment, configure the electronic device not to be selected as a reception device which receives a user utterance in the multi-device environment, and on the basis of the determination that the environment is not a multi-device environment, cause the electronic device, as the reception device, to receive a user utterance. Various other embodiments identified through the specification are possible.

### TECHNICAL FIELD

Embodiments disclosed in this specification refer to a technology for processing a user utterance based on a multi-device environment (MDE).

### BACKGROUND ART

Nowadays, with the development of a speech recognition technology, a speech recognition function may be implemented in various electronic devices including microphones. For example, a voice assistance service capable of providing an intuitive interface between electronic devices has recently been developed. The voice assistance service may infer a user's intent by performing natural language processing on the user's utterance, and may allow a control device to be controlled based on the inferred intent of the user. In particular, there is an increasing need for a technology capable of organically transmitting and receiving information between a plurality of electronic devices through speech recognition and seamlessly performing operations corresponding to utterances.

### DISCLOSURE

### Technical Problem

In an MDE, when a specific device is selected as an electronic device (hereinafter, a term ‘listener’ or ‘listener device’ is used interchangeably) receiving a user's utterance while playing content, the corresponding device may stop playing the content. Moreover, when the electronic device playing content in the MDE is selected as an electronic device (hereinafter, the term ‘executor’ or ‘execution device’ is used interchangeably) performs an action corresponding to a user utterance, the corresponding device may stop playing the content. In the MDE, a plurality of devices capable of receiving the user utterance or executing the action corresponding to the user utterance may be present, and thus a voice assistant service may be effectively provided while an existing content playback is maintained, when the appropriate listener device and the appropriate execution device are selected based on situations.

Various embodiments of the disclosure provide an electronic device that may determine the MDE and may determine a device (a listener device) receiving a user utterance or a device (an execution device) executing an action corresponding to the user utterance based on operating states of devices within the MDE, and a user utterance processing method of the electronic device.

### Technical Solution

An electronic device according to an embodiment disclosed in the specification may include a microphone, a speaker, a display, a communication circuit, a memory, and a processor. The memory may store instructions, when executed by the processor, causing the electronic device to receive a user utterance through the microphone, to recognize whether content is being played through the display or the speaker when receiving a user utterance, to recognize whether there is at least one first external electronic device connected to the electronic device through the communication circuit when the content is being played, to determine whether an environment is a multi-device environment (MDE) related to a voice assistant service, based on at least part of information of the at least one first external electronic device connected to the electronic device and/or information of at least one second external electronic device registered in a user account, to configure the electronic device not to be selected as a listener device receiving a user utterance in the MDE based on a determination that the environment is the MDE, and to receive a user utterance as the listener device based on a determination that the environment is not the MDE.

Moreover, a user utterance processing method of an electronic device according to an embodiment disclosed in the specification may include receiving a user utterance, recognizing whether content is being played when receiving a user utterance, recognizing whether there is at least one first external electronic device connected to the electronic device when the content is being played, determining whether an environment is an MDE related to a voice assistant service, based on at least part of information of the at least one first external electronic device connected to the electronic device and/or information of at least one second external electronic device registered in a user account, configuring the electronic device not to be selected as a listener device receiving a user utterance in the MDE based on a determination that the environment is the MDE, and receiving a user utterance as the listener device based on a determination that the environment is not the MDE.

Furthermore, a storage medium according to an embodiment disclosed in the specification may store a program that, when executed by a processor, causes the electronic device to perform a method for processing a user utterance.

### Advantageous Effects

According to embodiments disclosed in the specification, a voice assistant service may be provided while an existing content playback is maintained, by determining an appropriate listener device and an appropriate execution device depending on situations in an MDE.

According to embodiments disclosed in the specification, the listener device and the execution device that will provide the voice assistant service may be determined based on operating states of devices (e.g., a content playback) in the MDE.

In addition, a variety of effects directly or indirectly understood via the specification may be provided.

### DESCRIPTION OF DRAWINGS

FIG. 1 is a block diagram of a voice assistant system, according to an embodiment.

FIG. 2 is a block diagram of an electronic device, according to an embodiment.

FIG. 3 is a block diagram of a server, according to an embodiment.

FIG. 4 is a diagram for describing an operation of providing a voice assistant service of an electronic device, according to an embodiment.

FIG. 5 is a diagram for describing an operation of providing a voice assistant service of an electronic device, according to an embodiment.

FIG. 6 is a diagram for describing an operation of providing a voice assistant service of an electronic device, according to an embodiment.

FIG. 7 is a diagram for describing an operation of providing a voice assistant service of an electronic device, according to an embodiment.

FIG. 8 is a flowchart of a user utterance processing method of a voice assistant system, according to an embodiment.

FIG. 9 is a flowchart of a user utterance processing method of an electronic device, according to an embodiment.

FIG. 10 is a flowchart of a user utterance processing method of an electronic device, according to an embodiment.

FIG. 11 is a flowchart of a user utterance processing method of an electronic device, according to an embodiment.

FIG. 12 is a block diagram of an electronic device in a network environment, according to various embodiments.

FIG. 13 is a block diagram illustrating an integrated intelligence system, according to an embodiment.

FIG. 14 is a diagram illustrating the form in which relationship information between a concept and an action is stored in a database, according to an embodiment.

FIG. 15 is a view illustrating a user terminal displaying a screen of processing a voice input received through an intelligent app, according to an embodiment.

With regard to description of drawings, the same or similar components will be marked by the same or similar reference signs.

### MODE FOR INVENTION

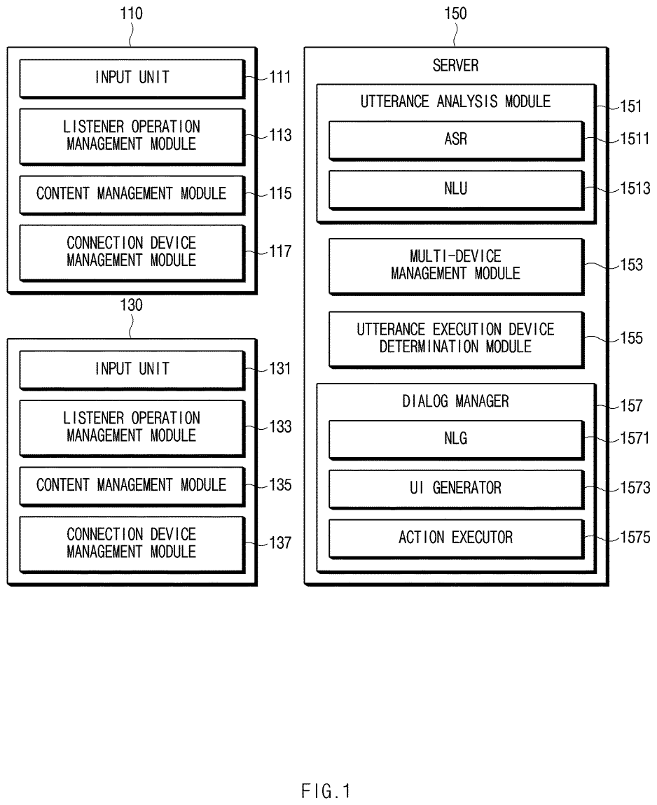

FIG. 1 is a block diagram of a voice assistant system, according to an embodiment.

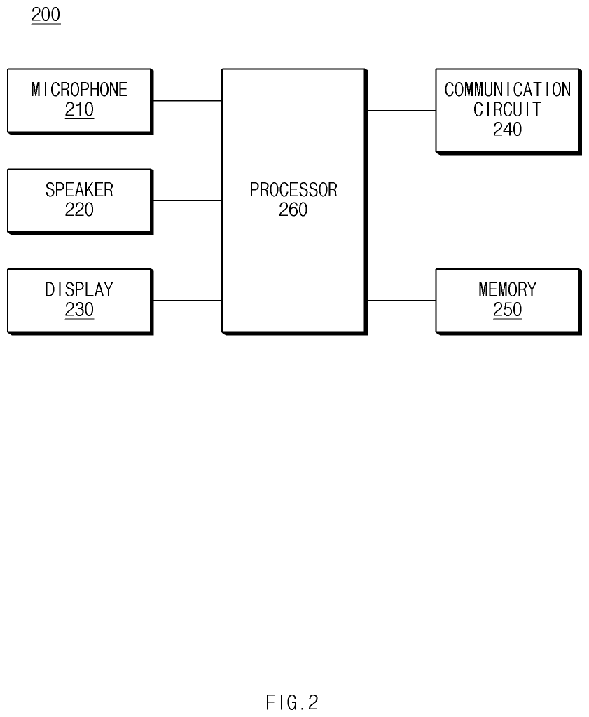

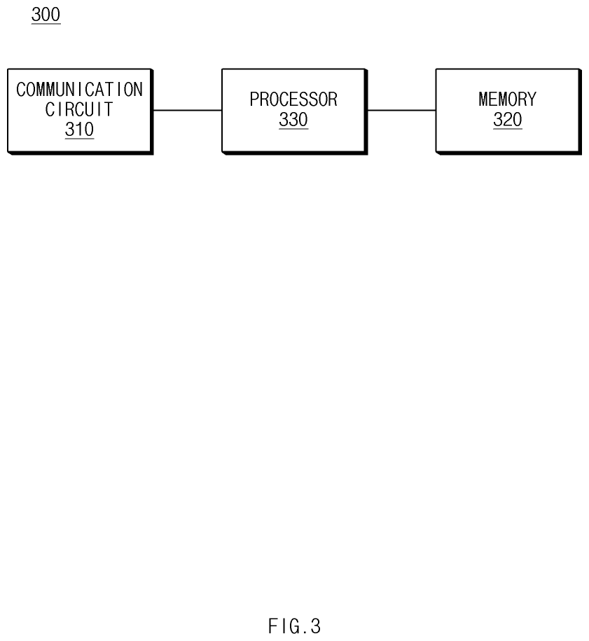

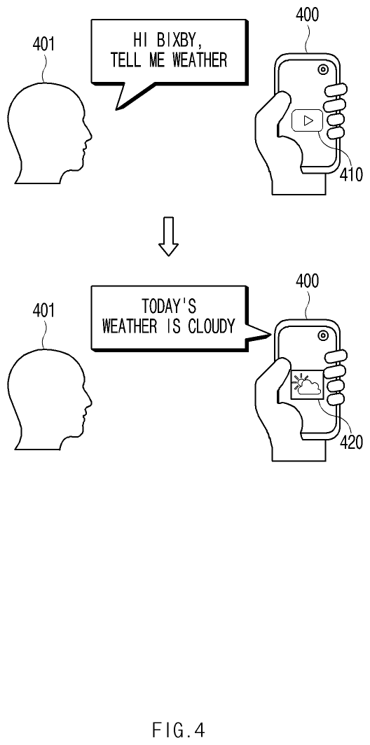

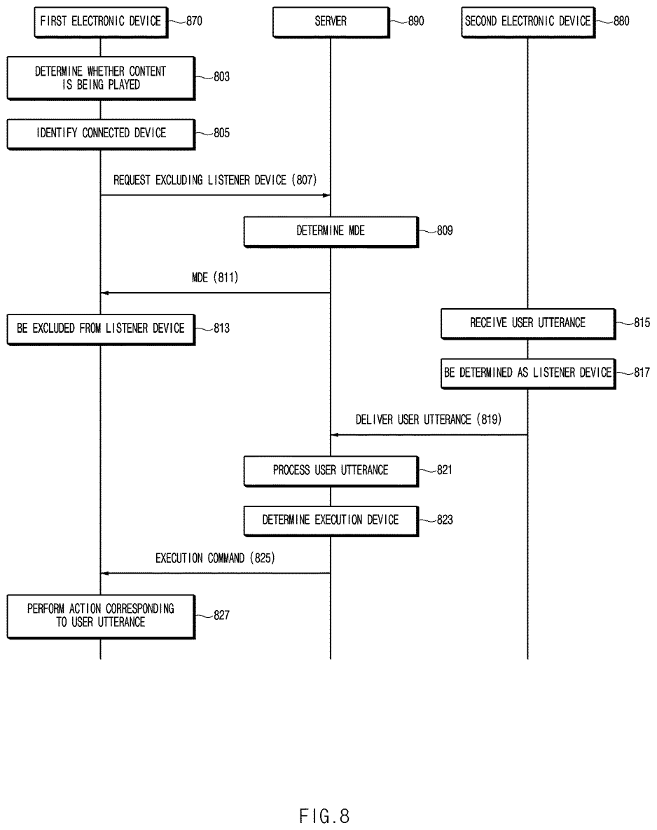

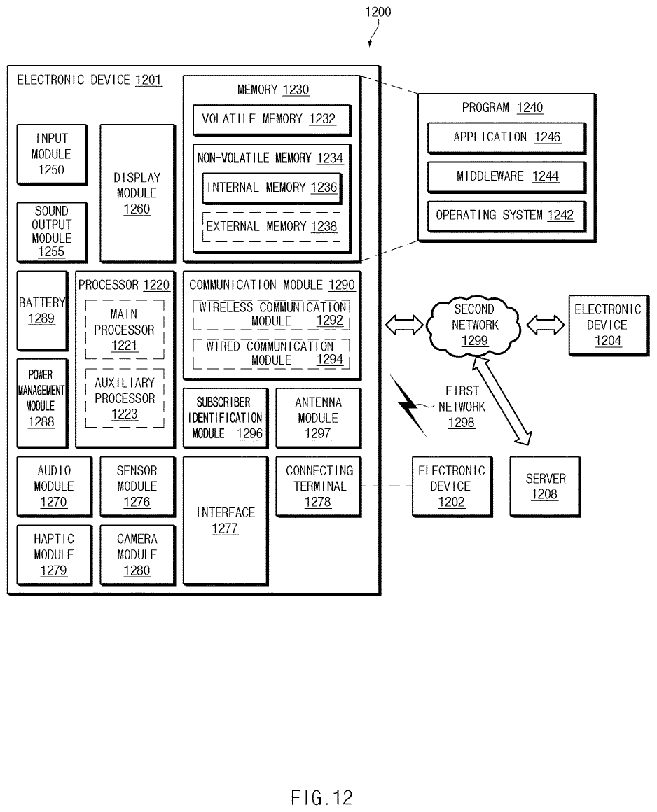

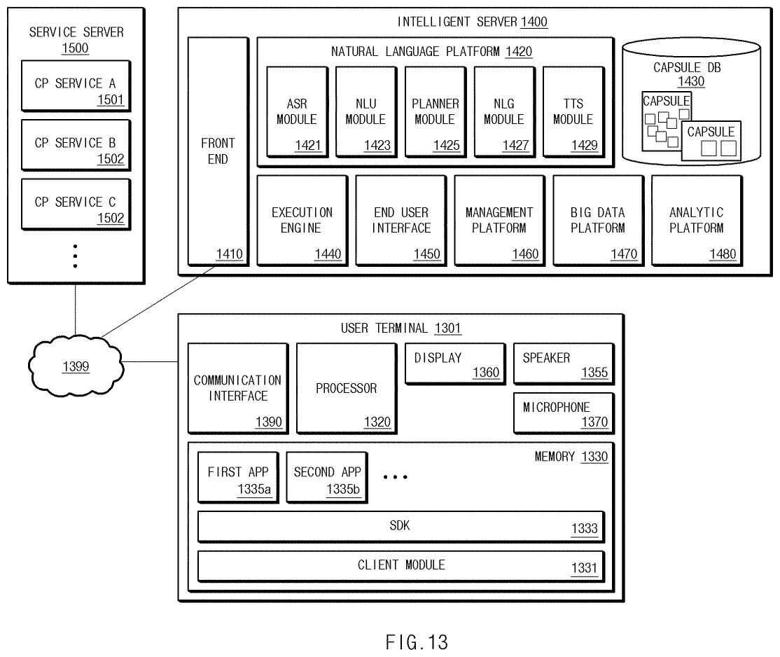

According to one embodiment, a voice assistant system may include at least one electronic device (e.g., an electronic device 200 of FIG. 2, first devices 400, 510, 610, and 710 of FIGS. 4 to 7, a first electronic device 870 of FIG. 8, an electronic device 1201 of FIG. 12, or a user terminal 1301 of FIGS. 13 to 15) and a server device 150 (e.g., a server device 300 of FIG. 3, a server 890 of FIG. 8, a server 1208 of FIG. 12, an intelligent server 1400 or a service server 1500 of FIGS. 13 to 15). Hereinafter, the voice assistant system is described as including, but not limited to, two electronic devices (a first device 110 and a second device 130). Hereinafter, the first device 110 and the second device 130 are described as having the same configuration, but not limited to thereto. The first device 110 and the second device 130 may include at least some different configurations.

According to an embodiment, each of the electronic devices (e.g., the first device 110 and the second device 130) may include an input unit 111 or 131 (e.g., a microphone 210 of FIG. 2, an audio module 1270 of FIG. 12, or a microphone 1370 of FIG. 13), a listener operation management module 133, a content management module 135, and a connection device management module 137.

According to an embodiment, the input units 111 and 131 may receive user utterances. For example, the input units 111 and 131 may include at least one microphone. The input units 111 and 131 may receive a user utterance by using at least one microphone.

According to an embodiment, the listener operation management module 133 may manage operation settings as a listener of an electronic device. For example, when an electronic device is configured not to be selected as a listener, the listener operation management module 133 may prevent the electronic device from recognizing user utterances.

According to an embodiment, the content management module 135 may manage whether content such as video, music, or games is played on the electronic device. For example, when the content is played, the content management module 135 may send, to the server device 150, a request for determining whether an environment is an MDE. The request may include information about devices connected to the electronic device (e.g., information recognized by the connection device management module 137).

The connection device management module 137 may recognize information related to the devices connected to the electronic device. For example, the connection device management module 137 may detect states, locations, and/or functions (e.g., whether it is capable of operating as a listener or an executor) of devices connected to the electronic device. For example, the connection device management module 137 may recognize the location of each of the devices wirelessly connected to the electronic device, the connection state of each of the devices, and/or whether each of the devices supports an operation of a listener or an executor.

According to an embodiment, the server device 150 may include an utterance analysis module 151 (e.g., a natural language platform 1420 of FIG. 13), a multi-device management module 153, an utterance execution device determination module 155, and a dialog manager 157.

According to an embodiment, the utterance analysis module 151 may grasp intent and/or domain for a user input (i.e., a user utterance) by performing natural language processing on the utterance obtained from a user. For example, the voice processing module may generate a natural language processing result of a user input, based on natural language understanding. According to an embodiment, the utterance analysis module 151 may include an auto speech recognition module (ASR) 1511, and a natural language understanding module (NLU) 1513.

According to an embodiment, the ASR 1511 may generate text data expressing the received utterance in a specified language. The ASR 1511 may generate text data by using an acoustic model and a language model. The acoustic model may include information associated with phonation, and the language model may include unit phoneme information and information about a combination of unit phoneme information. For example, the ASR 1511 may convert a user utterance into text data by using the information associated with phonation and unit phoneme information.

According to an embodiment, the NLU 1513 may grasp the intent for a user input or may grasp a matching domain, by using a natural language processing model with respect to text data generated by the ASR 1511. The NLU 1513 may obtain a component (e.g., a slot and a task parameter) necessary to express the user's intent. For example, the NLU 1513 may process utterance data based on syntactic analysis and semantic analysis. The domain or intent corresponding to the utterance is determined based on the processing result, and the component necessary to express the user's intent may be obtained.

According to an embodiment, the multi-device management module 153 may determine whether there is a device (e.g., a listener or a listener device) capable of receiving a user utterance and/or a device (e.g., an executor or an execution device) capable of performing an action corresponding to the user utterance in the space where the electronic device receiving the user utterance is located. For example, when the first device 110 receives a user utterance while providing content, the multi-device management module 153 may determine, in relation to the voice assistant service, whether a device capable of operating as a listener device for receiving a user utterance and/or a device capable of operating as an execution device for executing the user utterance, not the first device 110, is present in the same space as the space where the first device 110 is present. For example, the multi-device management module 153 may recognize whether there is a device connected to the first device 110 via wireless communication (e.g., Bluetooth or Wi-Fi). For example, the multi-device management module 153 may receive information about a device connected to the first device 110 from the first device 110. For example, when there is a device connected to the first device 110, the multi-device management module 153 determines that the first device 110 is in the MDE associated with the voice assistant service and may prevent the first device 110 from operating as a listener device. For example, the multi-device management module 153 may exclude the first device 110 from competing with a plurality of devices for determining a listener device receiving a user utterance in connection with the voice assistant service. According to an embodiment, when no device is connected to the first device 110, the multi-device management module 153 may determine the MDE based on information related to a user account (e.g., device information registered in the user account). For example, the multi-device management module 153 may obtain location information of devices registered in the user account and may determine whether a device registered in the user account is present at the same location as the first device 110. For example, when a device registered in the user account is present in the same location as the first device 110, the multi-device management module 153 may determine the MDE and may prevent the first device 110 from operating as a listener device. For example, when the first device 110 is providing content, the multi-device management module 153 may determine whether the second device 130 is capable of operating as a listener device receiving a user utterance. When the second device 130 is wirelessly connected to the first device 110 in the same space as the first device 110, or when the second device 130 is registered in the same user account as the first device 110, the multi-device management module 153 may determine the MDE. When the first device 110 is providing content in the MDE, the multi-device management module 153 may determine the second device 130 as a listener device. When the first device 110 finishes providing content, the multi-device management module 153 may determine the first device 110 as a listener device.

According to an embodiment, the utterance execution device determination module 155 may determine a device (i.e., an execution device) that will perform an action corresponding to a user utterance. For example, the utterance execution device determination module 155 may determine a device, which will perform an action corresponding to a user utterance, from among devices included in the MDE. For example, when the multi-device management module 153 determines that the first device 110 is not selected as a listener device, the utterance execution device determination module 155 may not determine the first device 110 as an execution device when there is another device, which will execute a user utterance, in the MDE. For example, when the first device 110 is providing content, the utterance execution device determination module 155 may not determine the first device 110 as an execution device. For example, when the first device 110 is required to perform an action corresponding to a user utterance, the utterance execution device determination module 155 may determine the first device 110 as an execution device. For example, when the first device 110 is providing content, the utterance execution device determination module 155 may determine whether the second device 130 is capable of performing an action corresponding to a user utterance. When the second device 130 may perform an action corresponding to a user utterance, the utterance execution device determination module 155 may determine the second device 130 as an execution device. When the second device 130 may not perform an action corresponding to a user utterance, the utterance execution device determination module 155 may determine the first device 110 as an execution device. When the first device 110 finishes providing content, the utterance execution device determination module 155 may determine the first device 110 as an execution device.

According to an embodiment, the dialog manager 157 may include a natural language generator (NLG) 1571, a user interface (UI) generator 1573, and an action executor 1575.

According to an embodiment, the NLG 1571 may generate data, which is generated while natural language processing is performed, in a natural language form. The data generated in a natural language form may be the result of natural language understanding. For example, the NLG 1571 may generate an execution result indicating whether a control operation corresponding to a control utterance has been performed by a plurality of executors, in a natural language form.

According to an embodiment, the UI generator 1573 may generate a UI screen for providing a natural language generated by the NLG 1571.

According to an embodiment, the action executor 1575 may allow an electronic device (e.g., the first device 110 or the second device 130) to perform a specific action to provide the voice assistant service.

According to various embodiments, the configuration of the voice assistant system and the configuration of the first device 110, the second device 130, and the server device 150 may be changed. For example, at least some of the components of the first device 110, the second device 130, and the server device 150 may be omitted, or new components may be added. According to various embodiments, an electronic device (the first device 110 or the second device 130) may perform at least some of the operations of the server device 150, and the server device 150 may perform at least some of the operations of the electronic device.

According to an embodiment, a listener operation management module 113 or 133, a content management module 115 or 135, and a connection device management module 117 or 137 of an electronic device (e.g., the first device 110 or the second device 130) may be implemented as a single integrated component (e.g., a processor (e.g., a processor 260 of FIG. 2, a processor 1220 of FIG. 12, or a processor 1320 of FIG. 13)), or at least some of the operations of the listener operation management module 113 or 133, the content management module 115 or 135, and the connection device management module 117 or 137 may be performed by the processor of the electronic device.

According to an embodiment, when a specific device is providing content in the MDE, the voice assistant system may seamlessly provide a voice assistant service while maintaining content delivery by excluding the corresponding device from a listener device and/or an execution device.

FIG. 2 is a block diagram of an electronic device, according to an embodiment.

According to an embodiment, the electronic device 200 (e.g., the electronic device 200 of FIG. 2, first devices 400, 510, 610, and 710 of FIGS. 4 to 7, the first electronic device 870 of FIG. 8, the electronic device 1201 of FIG. 12, or the user terminal 1301 of FIGS. 13 to 15) may include the microphone 210 (e.g., the input units 111 and 131 of FIG. 1, the audio module 1270 of FIG. 12, the microphone 1370 of FIG. 13), a speaker 220 (e.g., a sound output module 1255 of FIG. 12, or a speaker 1355 of FIG. 13), a display 230 (e.g., a display module 1260 of FIG. 12 or a display 1360 of FIG. 13), a communication circuit 240 (e.g., a communication module 1290 of FIG. 12 or a communication interface 1390 of FIG. 13), a memory 250 (e.g., a memory 1230 of FIG. 12 or a memory 1330 of FIG. 13), and the processor 260 (e.g., the processor 1220 of FIG. 12 or the processor 1320 of FIG. 13).

According to an embodiment, the microphone 210 may receive a user utterance.

According to an embodiment, the speaker 220 may output auditory content. The speaker 220 may output a sound corresponding to the received user utterance, a result of processing the user utterance, and/or a result of performing an action corresponding to the user utterance.

According to an embodiment, the display 230 may output visual content. The display 230 may visually output text corresponding to the received user utterance, a result of processing the user utterance, and/or a result of performing an action corresponding to the user utterance.

According to an embodiment, the communication circuit 240 may exchange information and/or data with an external electronic device or an external server device (e.g., the server device 150 of FIG. 1, the server device 300 of FIG. 3, the server 890 of FIG. 8, the server 1208 of FIG. 12, or the intelligent server 1400 or the service server 1500 of FIGS. 13 to 15).

According to an embodiment, the memory 250 may store instructions for controlling an operation of the electronic device 200 when executed by the processor 260. The memory 250 may store, at least temporarily, information and/or data related to the operation of the electronic device 200 (e.g., data related to a user utterance, information related to an external electronic device (e.g., location information or network connection information), information related to an external server device, user account information, information about a listener device and/or an execution device, and/or information about an action corresponding to a user utterance).

According to an embodiment, when receiving a user utterance, the processor 260 may recognize whether content is being played. For example, the processor 260 may visually or audibly recognize whether content is being played. According to an embodiment, when the content is not being played, the processor 260 may allow the electronic device 200 to operate as a listener device receiving a user utterance, regardless of whether an environment is an MDE.

According to an embodiment, when the electronic device 200 is playing content, the processor 260 may recognize whether there is at least one first external electronic device connected to the electronic device 200. For example, the processor 260 may determine whether there is at least one first external electronic device connected via wireless communication (e.g., Bluetooth or Wi-Fi) and may recognize information of at least one first electronic device 200 thus connected.

According to an embodiment, the processor 260 may determine whether the environment is the MDE related to a voice assistant service, based on at least part of information of at least one first external electronic device connected to the electronic device 200 and/or information of at least one second external electronic device registered in a user account. For example, the processor 260 may determine whether at least one first external electronic device connected via wireless communication is capable of operating as a listener device of the voice assistant service. For example, when there is at least one first external electronic device capable of operating as a listener device, the processor 260 may determine the MDE. For example, the processor 260 may determine whether at least one second external electronic device registered to the user account is in the same location (or adjacent location, space, or place) as the electronic device 200. For example, the processor 260 may determine whether the electronic device 200 and at least one second external electronic device are in the same location, by comparing network connection information (e.g., wireless network connection IP address, MAC address, or SSID) and location information (e.g., GPS information) of the electronic device 200 with network connection information and location information (e.g., GPS information, or location information of the electronic device 200 included in user account information) of at least one second external electronic device registered in a user account. The processor 260 may determine the MDE when at least one second external electronic device registered in the user account is located in the same location. According to an embodiment, the processor 260 may transmit user account information and/or information about at least one first external electronic device connected to at least one external server associated with a voice assistant service, and may receive information indicating whether the environment is the MDE, from the at least one external server.

According to an embodiment, the processor 260 may set the electronic device 200 not to be selected as a listener device for receiving a user utterance, based on the determination that the environment is the MDE. For example, the processor 260 may not participate in competition for selecting a listener device in the MDE (e.g., wake-up competition). For example, the processor 260 may send a listener device exception request to at least one external server associated with the voice assistant service. For example, at least one external server associated with the voice assistant service may exclude the electronic device 200 from competing to determine a listener device in response to the request. According to an embodiment, the processor 260 may maintain playback of the content by being excluded from the listener device.

According to an embodiment, the processor 260 may set the electronic device 200 to participate in competition for determining a listener device when playback of the content ends. For example, when playback of content ends, the processor 260 may send a request for re-joining the competition for determining the listener device to at least one external server associated with the voice assistant service.

According to an embodiment, the processor 260 may receive a user utterance as a listener device based on the determination that the environment is not the MDE. For example, the processor 260 may determine an action corresponding to the user utterance by processing the user utterance, and may allow an execution device to perform the action corresponding to the user utterance. For example, the processor 260 may transmit information corresponding to the user utterance (e.g., the user utterance, data obtained by converting the user utterance into speech-to-text (STT), and/or data obtained by performing natural language processing on the user utterance) to at least one external server associated with the voice assistant service. For example, at least one server may determine an execution device based on information corresponding to the user utterance and may allow the execution device to perform an action corresponding to the user utterance. According to an embodiment, when the electronic device 200 operates as a listener device (is selected as a listener device), the processor 260 may stop playing content.

According to an embodiment, when the electronic device 200 is playing content, the processor 260 may be excluded from the execution device, and the processor 260 may maintain playback of the content. When the electronic device 200 operates as an execution device, the processor 260 may stop playing the content or may play other content depending on an action corresponding to a user utterance. For example, the processor 260 may change the content played based on the action corresponding to the user utterance.

According to an embodiment of the disclosure, in providing a voice assistant service in the MDE, when the electronic device 200 is playing content, the electronic device 200 may be configured such that the electronic device 200 is not selected in determining a listener device and/or an execution device associated with the voice assistant service, thereby providing the voice assistant service while maintaining content playback.

FIG. 3 is a block diagram of a server device, according to an embodiment.

According to an embodiment, the server device 300 (e.g., the server device 150 of FIG. 1, the server 890 of FIG. 8 , the server 1208 of FIG. 12 , or the intelligent server 1400 or the service server 1500 of FIGS. 13 to 15) may include a communication circuit 310, a memory 320, and a processor 330.

According to an embodiment, the communication circuit 310 may exchange information and/or data with an external electronic device (e.g., the first device 110 of FIG. 1, the second device 130, the electronic device 200 of FIG. 2, the first devices 400, 510, 610, and 710 of FIGS. 4 to 7, the first electronic device 870 of FIG. 8, the electronic device 1201 of FIG. 12, or the user terminal 1301 of FIGS. 13 to 15) or an external server device.

According to an embodiment, the memory 320 may store instructions for controlling an operation of the server device 300 when executed by the processor 330. The memory 320 may store, at least temporarily, information and/or data related to the operation of the server device 300 (e.g., data related to a user utterance, information related to an external electronic device (e.g., location information or network connection information), user account information, information about a listener device and/or an execution device, and/or information about an action corresponding to a user utterance).

According to an embodiment, the processor 330 may receive a request for not being selected as a listener device for receiving user utterances for a voice assistant service, from an external electronic device playing content. For example, the request may include information about at least one external device connected to an external electronic device via wireless communication. For example, the request may include information about a user account of the external electronic device. For example, the information about a user account may include information about a device registered in the user account.

According to an embodiment, the processor 330 may determine whether an external electronic device is in an MDE associated with the voice assistant service. For example, the processor 330 may determine whether there is a device, which is capable of operating as a listener device for the voice assistant service, from among other devices connected to the external electronic device. The processor 330 may determine that the external electronic device is in the MDE, when there is a device, which is capable of operating as a listener device for the voice assistant service, from among other devices connected to the external electronic device. For example, the processor 330 may determine whether there is a device, which is in the same location (or adjacent location, space, or place) as the external electronic device, from among devices registered in a user account. The processor 330 may determine that the external electronic device is in the MDE, when there is a device, which is in the same location (or adjacent location, space, or place) as the external electronic device, from among devices registered in a user account. For example, the processor 330 may determine whether the external electronic device and the device registered in the user account are in the same location (or adjacent location, space, or place) based on the location information and/or network connection information of the external electronic device and the location information and/or network connection information of the device registered in the user account.

According to an embodiment, the processor 330 may prevent an external electronic device from being selected as a listener device, based on the determination that the environment is the MDE. For example, the processor 330 may prevent the external electronic device from competing in a process of determining a listener device.

According to an embodiment, the processor 330 may select the external electronic device as a listener device based on the determination that the external electronic device is not in the MDE. For example, the processor 330 may allow the external electronic device to operate as a listener device. For example, the processor 330 may receive information corresponding to a user utterance received from the external electronic device, may process the user utterance, and may determine an action corresponding to the user utterance. The processor 330 may determine an execution device that will perform an action corresponding to a user utterance, and may transmit a command to the execution device for performing the action corresponding to the user utterance.

According to an embodiment, the processor 330 may receive information related to a user utterance from a listener device different from an external electronic device playing content in the MDE. The information related to a user utterance may include a user utterance, data obtained by recognizing the user utterance, data obtained by converting the user utterance, and/or data obtained by performing natural language processing on the user utterance.

According to an embodiment, the processor 330 may determine the action corresponding to the user utterance based on the information related to the user utterance. According to an embodiment, when there is an execution device performing the action corresponding to the user utterance other than the external electronic device, the processor 330 may transmit a command for performing the action corresponding to the user utterance to the execution device. For example, the processor 330 may determine an execution device other than the external electronic device and may allow the execution device to perform an action corresponding to a user utterance, thereby allowing the external electronic device to continue playing content.

According to an embodiment, when there is no execution device performing the action corresponding to the user utterance other than the external electronic device, the processor 330 may transmit a command for performing the action corresponding to the user utterance to the external electronic device. For example, the processor 330 may determine an external electronic device as an execution device that performs an action corresponding to a user utterance. For example, the external electronic device may perform the action corresponding to the user utterance, thereby at least temporarily stopping playback of content. According to an embodiment, even though there is an execution device, other than the external electronic device, which performs an action corresponding to a user utterance, when an operation of the external electronic device is requested (e.g., when the external electronic device is specified by the user utterance, or when the action corresponding to the user utterance is an action of playing the same type of content as content currently being played by the external electronic device (e.g., when it is an action of changing the content currently being played)), the processor 330 may transmit a command for performing the action corresponding to the user utterance to the external electronic device.

According to various embodiments, at least some configurations of the electronic device 200 of FIG. 2 and the server device 300 of FIG. 3 may be integrated with each other, or at least some operations thereof may be performed independently of or in conjunction with each other. For example, the electronic device 200 of FIG. 2 may perform the operations of the server device 300 of FIG. 3 on an on-device.

According to an embodiment of the disclosure, in providing a voice assistant service in an MDE, when an external electronic device is playing content, the server device 300 may provide the voice assistant service while the external electronic device continues to play the content, by not selecting the external electronic device as a listener device and/or an execution device associated with the voice assistant service.

FIGS. 4 to 7 are drawings for describing an operation of providing a voice assistant service of an electronic device, according to an embodiment. Although in descriptions in FIGS. 4 to 7, it is assumed that specific electronic devices 400, 510, 610, and 710 (e.g., the first device 110 of FIG. 1, the second device 130, the electronic device 200 of FIG. 2, the first devices 400, 510, 610, and 710 of FIGS. 4 to 7, the first electronic device 870 of FIG. 8, the electronic device 1201 of FIG. 12, or the user terminal 1301 of FIGS. 13 to 15) are playing video content, the description is not limited thereto. The same description may also be applied to playing voice (sound) content.

Referring to FIG. 4, an operation for providing a voice assistant service is shown in a case other than an MDE. For example, while the first electronic device 400 is playing content 410, when a user 401 enters an utterance of the user 401 (“Hi Bixby, tell me the weather”) into the first electronic device 400, the first electronic device 400 may stop playing the content 410 and may perform an action corresponding to the utterance of the user 401. For example, the first electronic device 400 may stop playing the content 410, then may output a weather-related UI 420 to a display, or may output weather information (“Today's weather is cloudy”) by voice.

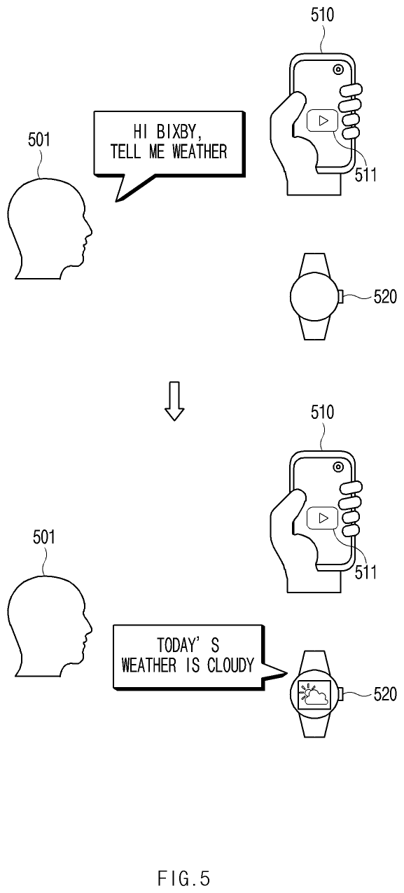

Referring to FIG. 5, an operation of providing a voice assistant service in an MDE having a second electronic device 520 (e.g., a wearable device) capable of operating as a listener device and an execution device around a first electronic device 510 is illustrated.

For example, when a user 501 enters an utterance of the user 501 (“Hi Bixby, tell me the weather”) into the first electronic device 510 while the first electronic device 510 is playing content 511, the second electronic device 520 may be determined as a listener device for providing the voice assistant service. For example, the first electronic device 510 may maintain playback of the content 511, and the second electronic device 520 may process the utterance of the user 501 (“Hi Bixby, tell me the weather”) and may perform an action corresponding to the utterance of the user 501. For example, the second electronic device 520 may output a weather-related UI 511 to a display, or may output weather information (“Today's weather is cloudy”) by voice.

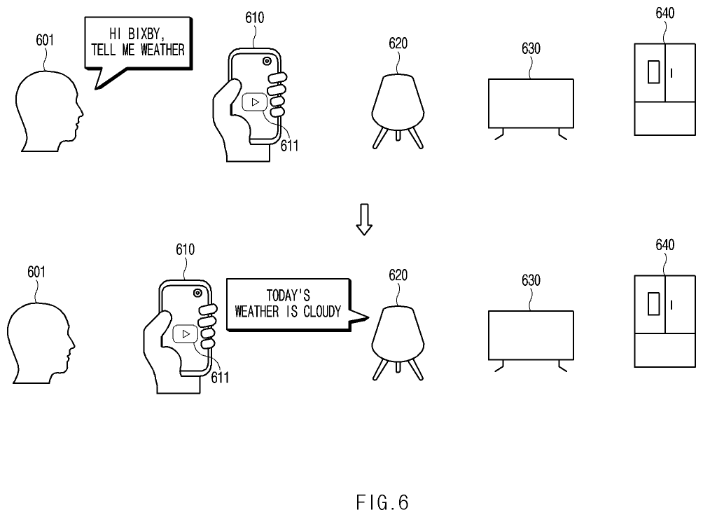

Referring to FIG. 6, an operation of providing a voice assistant service in an MDE having a plurality of electronic devices capable of operating as a listener device and an execution device around a first electronic device 610 is illustrated. For example, a second electronic device 620 may be a smart speaker capable of operating as a listener device or an execution device, a third electronic device 630 may be a smart TV capable of operating as an execution device, and a fourth electronic device 640 may be a smart refrigerator capable of operating as an execution device. For example, at least one of a plurality of devices may be an IoT hub device.

For example, when an utterance of a user 601 (“Hi Bixby, tell me the weather”) is entered from the user 601, the voice assistant system may determine a listener device, which receives the utterance of the user 601, from among a plurality of electronic devices within the MDE. For example, at least one listener device among the plurality of electronic devices may be determined through competition (e.g., wake up competition) for determining the listener device in response to a wake-up word included in the utterance of the user 601. According to an embodiment, when the first electronic device 610 is playing content 611 when the utterance of the user 601 is entered, the first electronic device 610 may be excluded from the competition for determining a listener device. In this case, the second electronic device 620, the third electronic device 630, and the fourth electronic device 640 may compete to be determined as the listener device. For example, the voice assistant system may determine the confidence of each device in consideration of the state, Reference Signal Received Power (RSRP), Signal-to-Noise Ratio (SNR), and/or surrounding environment of each of the second electronic device 620, the third electronic device 630, and the fourth electronic device 640, and may determine the electronic device with the highest confidence as a listener device.

For example, in FIG. 6, it is assumed that the second electronic device 620 capable of operating as a listener device is determined as a listener device and an execution device. The first electronic device 610 may maintain playback of the content 611. The second electronic device 620, as a listener device, may receive and process the utterance of the user 601. The second electronic device 620 may perform an action corresponding to the utterance of the user 601. For example, the second electronic device 620 may output weather information (“Today's weather is cloudy”) by voice. For example, FIG. 6 illustrates that the second electronic device 620 is selected as an execution device performing the action corresponding to the utterance of the user 601, but is not limited thereto. The third electronic device 630 and the fourth electronic device 640 may also be selected as execution devices. According to an embodiment, when the first electronic device 610 is playing the content 611, the first electronic device 610 may not be selected as an execution device. For example, when the first electronic device 610 is playing content 611, and there is a device performing an action corresponding to the utterance of the user 601 other than the first electronic device 610, the first electronic device 610 may not be selected as an execution device and may maintain playback of the content 611.

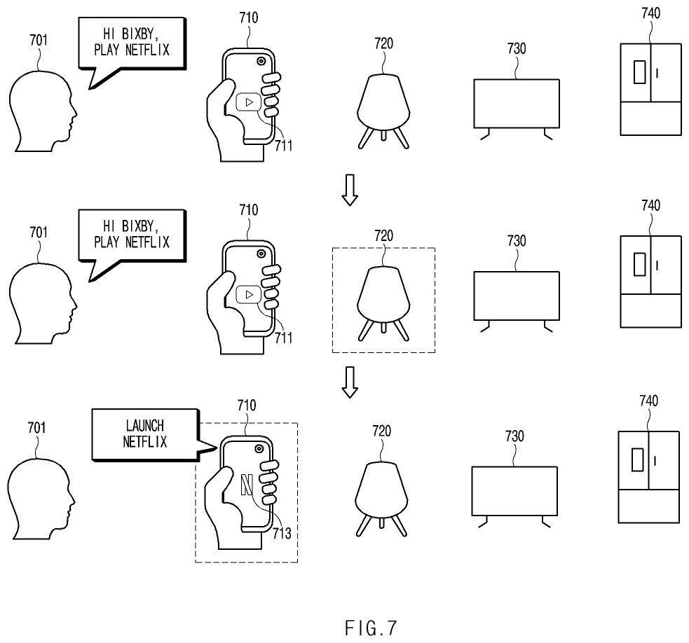

Referring to FIG. 7, an operation of providing a voice assistant service in an MDE having a plurality of electronic devices capable of operating as a listener device and an execution device around a first electronic device 710 is illustrated. For example, a second electronic device 720 may be a smart speaker capable of operating as a listener device or an execution device, a third electronic device 730 may be a smart TV capable of operating as an execution device, and a fourth electronic device 740 may be a smart refrigerator capable of operating as an execution device.

For example, when a user utterance (“Hi Bixby, play Netflix”) is entered from a user 701, the voice assistant system may determine a listener device, which receives the utterance of the user 701, from among a plurality of electronic devices within an MDE. For example, when the first electronic device 710 is playing content 711, the second electronic device 720, the third electronic device 730, and the fourth electronic device 740, excluding the first electronic device 710, may compete to be determined as a listener device. For example, in FIG. 7, it is assumed that the second electronic device 720 capable of operating as a listener device is determined as a listener device, and the first electronic device 710 is determined as an execution device. For example, even when the first electronic device 710 is configured not to participate in listener device competition and not to be selected as a listener device, the first electronic device 710 may be selected as an execution device. For example, when no device in the MDE is capable of performing the action corresponding to the user utterance, when the user utterance is a request that specifies the first electronic device 710 and allows the first electronic device 710 to perform the action, or when the first electronic device 710 is an electronic device, which is most suitable for performing the action corresponding to the user utterance, the first electronic device 710 may be selected as an execution device. For example, FIG. 7 illustrates that a user utterance for playing second video content 713 is input while the first electronic device 710 is playing first video content 711. For example, the third electronic device 730 (e.g., a smart TV) may be selected as an execution device for playing the second video content 713. However, the user 701 may not simultaneously watch the first video content 711 and the second video content 713, but may want to watch the second video content 713 through the first electronic device 710, through which the user 701 is currently watching the first video content 711. In this case, the voice assistant system may determine the first electronic device 710 as an execution device and may allow the first electronic device 710 to play the second video content 713 instead of the first video content 711.

According to an embodiment of the disclosure, in providing a voice assistant service in an MDE, when a specific electronic device (e.g., the first electronic device) is playing content, the voice assistant service may be seamlessly provided while content playback is maintained, by determining a listener device and/or an execution device associated with the voice assistant service, excluding the electronic device playing the content.

An electronic device according to an embodiment may include a microphone, a speaker, a display, a communication circuit, a memory, and a processor. The memory may store instructions, when executed by the processor, causing the electronic device to receive a user utterance through the microphone, to recognize whether content is being played through the display or the speaker when receiving a user utterance, to recognize whether there is at least one first external electronic device connected to the electronic device through the communication circuit when the content is being played, to determine whether an environment is a multi-device environment (MDE) related to a voice assistant service, based on at least part of information of the at least one first external electronic device connected to the electronic device and/or information of at least one second external electronic device registered in a user account, to configure the electronic device not to be selected as a listener device receiving a user utterance in the MDE based on a determination that the environment is the MDE, and to receive a user utterance as the listener device based on a determination that the environment is not the MDE.

According to an embodiment, when executed by the processor, the instructions may cause the electronic device to maintain playback of the content based on the determination that the environment is the MDE.

According to an embodiment, when executed by the processor, the instructions may cause the electronic device to determine that the environment is the MDE, based on information of the at least one first external electronic device when at least one external electronic device capable of operating as the listener device among the at least one first external electronic device is included.

According to an embodiment, when executed by the processor, the instructions may cause the electronic device to transmit information of the at least one first external electronic device to at least one external server associated with the voice assistant service, and to receive information indicating whether the environment is the MDE, from the at least one external server based at least partly on the information of the at least one first external electronic device.

According to an embodiment, when executed by the processor, the instructions may cause the electronic device to determine whether at least one external electronic device capable of operating as the listener device among the at least one second external electronic device is located at a location the same as the electronic device, and to determine that the environment is the MDE when there is at least one external electronic device located in the location the same as the electronic device.

According to an embodiment, when executed by the processor, the instructions may cause the electronic device to determine whether at least one external electronic device capable of operating as the listener device among the at least one second external electronic device is located at the location the same as the electronic device based on at least some of location information and network connection information of the at least one second external electronic device and at least some of location information and network connection information of the electronic device.

According to an embodiment, when executed by the processor, the instructions may cause the electronic device to send a request for determining whether the environment is the MDE, to at least one external server associated with the voice assistant service, and to receive information indicating whether the environment is the MDE, from the at least one external server based on whether at least one external electronic device capable of operating as the listener device among the at least one second external electronic device is located in the location the same as the electronic device.

According to an embodiment, when executed by the processor, the instructions may cause the electronic device to configure the electronic device to be excluded from competition for determining the listener device from among a plurality of electronic devices, which are included in the MIDE, in the MDE.

According to an embodiment, when executed by the processor, the instructions may cause the electronic device to configure the electronic device to participate in the competition when playback of the content ends after configuring the electronic device to be excluded from the competition.

According to an embodiment, the server device may include a communication circuit, a memory, and a processor. When executed by the processor, the memory may store instructions causing the server device to receive a request for not being selected as a listener device receiving a user utterance for a voice assistant service, from an external electronic device playing content, to determine whether the external electronic device is in an MDE associated with the voice assistant service, to configure the external electronic device not to be selected as the listener device based on a determination that the external electronic device is in the MDE, and to select the external electronic device as the listener device based on a determination that the external electronic device is not in the MDE.

According to an embodiment, when executed by the processor, the instructions may cause the server device to recognize at least one electronic device registered in a user account the same as the external electronic device, to determine whether there is an electronic device capable of operating as the listener device around the electronic device, based on at least some of location information and network connection information of the at least one electronic device and at least some of location information and network connection information of the external electronic device, and to determine that the external electronic device is in the MDE, based on a determination that there is an electronic device capable of operating as the listener device around the electronic device.

According to an embodiment, when executed by the processor, the instructions may cause the server device to receive information related to a user utterance from the listener device different from the external electronic device in the MDE, to determine an action corresponding to the user utterance based on the information related to the user utterance, to transmit a command for performing the action corresponding to the user utterance to the execution device when there is an execution device performing the action corresponding to the user utterance other than the external electronic device, and to transmit a command for performing the action corresponding to the user utterance to the external electronic device when there is no execution device performing the action corresponding to the user utterance other than the external electronic device.

FIG. 8 is a flowchart of a user utterance processing method of a voice assistant system, according to an embodiment. For example, in FIG. 8, it is assumed and described that a first electronic device, a second electronic device, and a server are included, but is not limited thereto. A voice assistant system may include a plurality of servers, or may include two or more electronic devices.

According to an embodiment, in operation 803, the first electronic device (e.g., the first device 110 of FIG. 1, the electronic device 200 of FIG. 2, the first electronic device 400, 510, 610, or 710 of FIGS. 4 to 7, or the first electronic device 870 of FIG. 8) may recognize whether content is being played. For example, the first electronic device may operate as a listener device, which receives and/or processes user utterances to provide the voice assistant service when the content is not being played.

According to an embodiment, when playing content, in operation 805, the first electronic device may determine whether there is an electronic device connected to the first electronic device. For example, the first electronic device may recognize the presence or absence of the electronic device connected via wireless communication (e.g., Bluetooth or Wi-Fi). For example, the first electronic device may determine whether the connected electronic device is a device capable of receiving a user utterance and/or a device supporting the voice assistant service. For example, when there is a device that is connected to the first electronic device and receives a user utterance and/or supports the voice assistant service, the corresponding device may operate as a listener device that receives the user utterance. For example, when there is a device that is connected to the first electronic device and receives the user utterance and/or supports the voice assistant service, the corresponding device may activate the voice assistant service in response to a wake-up word included in the user utterance.

According to an embodiment, in operation 807, the first electronic device may send a listener device exclusion request to the server (e.g., a server device (e.g., the server device 150 of FIG. 1, the server device 300 of FIG. 3, the server 890 of FIG. 8, the server 1208 of FIG. 12, the intelligent server 1400 of FIGS. 13 to 15, or the service server 1500). For example, the listener device exclusion request may include information about an electronic device connected to the first electronic device. For example, the listener device exclusion request may correspond to a request for determining whether an environment is an MDE. For example, when no other electronic device is connected, the first electronic device may send, to the server, a request for determining whether the environment is the MDE.

According to an embodiment, in operation 809, the server may determine whether the environment is the MDE. For example, the server may determine whether there is a device, which is capable of operating as a listener device and/or an execution device, from among electronic devices connected to the first electronic device. For example, the server may determine, based on information related to a user account, whether there is an electronic device, which is present in the same location (or adjacent location, place, or space) as the first electronic device, from among electronic devices registered in the same user account as the first electronic device. For example, the server may receive network connection information and/or location information (e.g., GPS information or wireless network IP address information) of the first electronic device, may receive network connection information (MAC address or SSID) and/or location (place) information of an electronic device registered in the user account from electronic devices registered in the user account, and may determine whether there is a device registered in the user account in the same (adjacent) space as the first electronic device based on the received information. For example, when there is an electronic device, which is capable of operating as a listener device or an execution device, from among electronic devices connected to the first electronic device, or when there is an electronic device that is registered in the same user account as the first electronic device and is present in the same space as the first electronic device, the server may determine the MDE.

According to an embodiment, in operation 811, the server may notify the first electronic device of the MDE. For example, the server may set the first electronic device not to be selected as a listener device in the MDE, or may request the first electronic device not to be selected as a listener device.

According to an embodiment, in operation 813, the first electronic device may be excluded from the listener device. For example, the first electronic device may be configured to be excluded from the listener device. For example, the first electronic device may not participate in competition for determining the listener device for providing the voice assistant service. For example, the first electronic device may not compute a confidence value for participating in the competition, or may not broadcast a signal including the confidence value for participating in the competition. For example, the first electronic device may maintain playback of the content by being excluded from the listener device. According to an embodiment, although not shown in FIG. 8, the first electronic device may participate in the competition for selecting a listener device again when content playback ends. For example, when content playback ends, the first electronic device may request the server such that the first electronic device is included as a listener device again, and may be determined to be a listener device based on the server's response.

According to an embodiment, in operation 815, the second electronic device may receive a user utterance as a listener device. For example, the user utterance may include a wake-up word for activating a voice assistant service. For example, the second electronic device may activate the voice assistant service (e.g., a voice assistant function (e.g., a voice assistant-related application)) in response to a wake-up word included in the user utterance.

According to an embodiment, in operation 817, the second electronic device may be determined as a listener device for providing the voice assistant service. For example, a specific electronic device (e.g., the second electronic device) within the MDE may be determined as a listener device through competition for determining the listener device. In FIG. 8, it is assumed and described that the second electronic device is determined as a listener device, but is not limited thereto. For example, when there is an electronic device (e.g., a wearable device) capable of receiving a user utterance from among electronic devices connected to the first electronic device, at least one of devices capable of receiving the user utterance among the devices connected to the first electronic device may be determined as a listener device. In an embodiment, the MDE may include more electronic devices. In this case, the electronic device with the highest confidence in competition (e.g., wake-up competition), excluding the first electronic device, may be determined as a listener device. For example, when a plurality of electronic devices participate in competition for determining a listener device, a device having the highest priority (e.g., the highest confidence value) among the plurality of devices participating in the competition may be determined as a listener device based on a value (e.g., a confidence value computed from the plurality of electronic devices based on information (e.g., signal-to-noise ratio (SNR)) related to surrounding environments and/or device states) computed from the plurality of electronic devices. For example, each of the plurality of devices participating in the competition may determine a confidence value for a wake-up word based on device states and/or communication states (e.g., SNR and/or transmission/reception signal strength), and may broadcast a signal including the determined confidence value so as to be shared. Each of the plurality of devices participating in the competition may compare its own confidence value with the received confidence value of another device, and an electronic device having the highest confidence may be determined as a listener device.

According to an embodiment, in operation 819, the second electronic device may transmit information corresponding to a user utterance to the server. For example, the second electronic device may recognize the user utterance and may transmit, to the server, the user utterance, data obtained by converting the user utterance into text, and/or data obtained by performing natural language processing on the user utterance.

According to an embodiment, in operation 821, the server may process the user utterance. For example, the server may grasp user intent from the user utterance by analyzing the user utterance and may determine an action corresponding to the user utterance.

According to an embodiment, in operation 823, the server may determine an execution device for performing the action corresponding to the user utterance. For example, the server may determine, as an execution device, an electronic device most suitable for performing the action corresponding to the user utterance within the MDE. In FIG. 8, it is assumed and described that the first electronic device is determined as an execution device, but is not limited thereto. For example, when the first electronic device is playing content, the server may determine an electronic device other than the first electronic device playing content as the execution device.

According to an embodiment, in operation 825, the server may transmit, to the execution device (e.g., the first electronic device), an execution command for performing the action corresponding to the user utterance.

According to an embodiment, in operation 827, the execution device (e.g., the first electronic device) may perform the action corresponding to the user utterance.

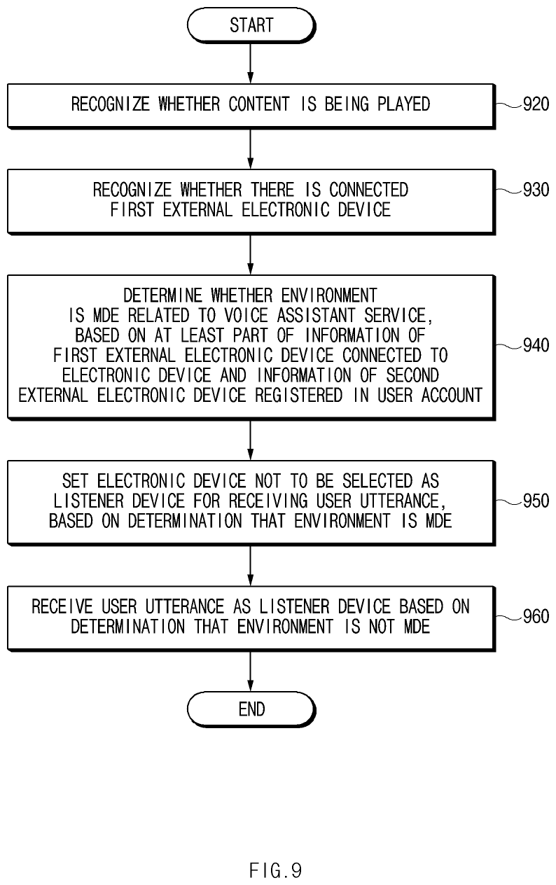

According to an embodiment, at least some of the operations of FIG. 8 may be omitted, or other operations (e.g., at least one of the operations of FIGS. 9 to 11) may be added, and the order of the operations may be changed. For example, in the case where operation 805 is omitted, when the first electronic device 870 does not determine whether there is a connected device, and identifies that content is playing in operation 803, in operation 807, the first electronic device 870 may send, to the server, a listener device exclusion request.

According to an embodiment of the disclosure, in providing a voice assistant service in an MDE, when a specific electronic device (e.g., the first electronic device) is playing content, the voice assistant service may be effectively provided while content playback is maintained, by determining a listener device and/or an execution device associated with the voice assistant service, excluding the electronic device playing the content.

FIG. 9 is a flowchart of a user utterance processing method of an electronic device, according to an embodiment.

According to an embodiment, in operation 920, an electronic device (e.g., the first device 110 of FIG. 1, the electronic device 200 of FIG. 2, the first electronic device 400, 510, 610, or 710 of FIGS. 4 to 7, or the first electronic device 870 of FIG. 8) may recognize whether content is being played. For example, the electronic device may visually or audibly recognize whether content is being played. For example, when playing the content, the electronic device may perform operations after operation 930. When not playing the content, the electronic device may operate as a listener device receiving a user utterance regardless of whether an environment is an MDE.

According to an embodiment, in operation 930, the electronic device may recognize whether there is at least one first external electronic device thus connected. For example, the electronic device may determine whether there is at least one first external electronic device connected via wireless communication (e.g., Bluetooth or Wi-Fi) and may recognize information of at least one first electronic device thus connected. For example, the electronic device may determine whether the first external electronic device thus connected is a device capable of receiving a user utterance and/or a device supporting the voice assistant service. For example, when there is a device that is connected to the electronic device and receives a user utterance and/or supports the voice assistant service, the corresponding device may operate as a listener device that receives the user utterance. For example, when there is a device that is connected to the first electronic device and receives the user utterance and/or supports the voice assistant service, the corresponding device may activate the voice assistant service in response to a wake-up word included in the user utterance.

According to an embodiment, in operation 940, the electronic device may determine whether the environment is the MDE related to a voice assistant service, based on at least part of information of at least one first external electronic device connected to the electronic device and/or information of at least one second external electronic device registered in a user account. For example, the electronic device may determine whether at least one first external electronic device connected via wireless communication is capable of operating as a listener device of the voice assistant service. For example, when there is at least one first external electronic device capable of operating as a listener device, the electronic device may determine the MDE. For example, the electronic device may determine whether at least one second external electronic device registered to the user account is in the same location (or adjacent location, space, or place) as the electronic device. For example, the electronic device may determine whether the electronic device and at least one second external electronic device are in the same location, by comparing network connection information (e.g., wireless network connection IP address, MAC address, or SSID) and location information (e.g., GPS information) of the electronic device with network connection information and location information (e.g., GPS information, or location information of the electronic device included in user account information) of at least one second external electronic device registered in a user account. The electronic device may determine the MDE when at least one second external electronic device registered in the user account is located in the same location. According to an embodiment, the electronic device may transmit user account information and/or information about at least one first external electronic device connected to at least one external server associated with a voice assistant service, and may receive information indicating whether the environment is the MDE, from the at least one external server.

According to an embodiment, in operation 950, the electronic device may set the electronic device not to be selected as a listener device for receiving a user utterance, based on the determination that the environment is the MDE. For example, the electronic device may not participate in competition for selecting a listener device in the MDE (e.g., wake-up competition). For example, the electronic device may send a listener device exception request to at least one external server associated with the voice assistant service. For example, at least one external server associated with the voice assistant service may exclude the electronic device from competing to determine a listener device in response to the request. For example, the electronic device may not compute a confidence value for the competition for determining a listener device, and/or may not broadcast a signal including a confidence value for participating in the competition. According to an embodiment, the electronic device may maintain playback of the content by being excluded from the listener device.

According to an embodiment, the electronic device may participate in the competition for determining a listener device when playback of the content ends. When playback of the content ends, the electronic device may send a request for re-joining the competition for determining the listener device to at least one external server associated with the voice assistant service. For example, when the electronic device participates in competition for determining a listener device, a device having the highest priority among a plurality of devices participating in the competition may be determined as a listener device based on a value (e.g., a confidence value computed from the plurality of devices based on information (e.g., SNR) related to surrounding environments and/or states) computed from the plurality of devices including the electronic device.

According to an embodiment, in operation 960, the electronic device may receive a user utterance as a listener device based on the determination that the MDE is not present. For example, the user utterance may include a wake-up word. The electronic device may activate a voice assistant service in response to the wake-up word. For example, the electronic device may activate a voice assistant function (e.g., a voice assistant application). For example, the electronic device may determine an action corresponding to the user utterance by processing the user utterance, and may allow an execution device to perform the action corresponding to the user utterance. For example, the electronic device may transmit information corresponding to the user utterance (e.g., the user utterance, data obtained by converting the user utterance into speech-to-text (STT), and/or data obtained by performing natural language processing on the user utterance) to at least one external server associated with the voice assistant service. For example, at least one server may determine an execution device based on information corresponding to the user utterance and may allow the execution device to perform an action corresponding to the user utterance. According to an embodiment, when the electronic device operates as a listener device (is selected as a listener device), the electronic device may stop playing content.

According to an embodiment, when the electronic device is playing the content, the electronic device may be excluded from the execution device, and the electronic device may maintain playback of the content. When the electronic device operates as an execution device, the electronic device may stop playing the content or may play other content depending on an action corresponding to a user utterance.

According to various embodiments, at least some of the operations of FIG. 9 may be omitted, or other operations (e.g., at least one of the operations of FIGS. 8, 10, and 11) may be added, and the order of at least some of the operations of FIG. 9 may be changed. For example, in the case where operation 930 is omitted, when the electronic device does not determine whether there is the connected first external electronic device, and identifies that content is playing in operation 920, the electronic device may perform operation 940.

According to an embodiment of the disclosure, in providing a voice assistant service in an MDE, when a specific electronic device is playing content, the voice assistant service may be provided while content playback is maintained, by determining a listener device and/or an execution device associated with the voice assistant service, excluding the electronic device playing the content.

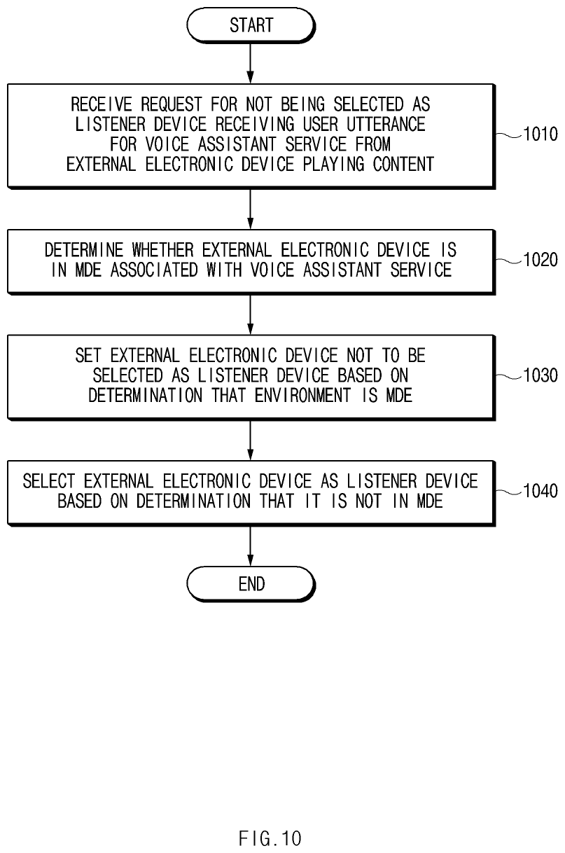

FIG. 10 is a flowchart of a user utterance processing method of an electronic device, according to an embodiment.

According to an embodiment, in operation 1010, an electronic device (e.g., a server device (e.g., the server device 150 of FIG. 1, the server device 300 of FIG. 3, the server 890 of FIG. 8, the server 1208 of FIG. 12, the intelligent server 1400 of FIGS. 13 to 15, or the service server 1500)) may receive a request for not being selected as a listener device receiving a user utterance for a voice assistant service, from an external electronic device (e.g., the first device 110 of FIG. 1, the electronic device 200 of FIG. 2, the first electronic device 400, 510, 610, or 710 of FIGS. 4 to 7, or the first electronic device 870 of FIG. 8) playing content. For example, the request may include information about at least one external device connected to an external electronic device via wireless communication. For example, the request may include information about a user account of the external electronic device. For example, the information about a user account may include information about a device registered in the user account.

According to an embodiment, in operation 1020, the electronic device may determine whether an external electronic device is in an MDE associated with the voice assistant service. For example, the electronic device may determine whether there is a device, which is capable of operating as a listener device for the voice assistant service, from among other devices connected to the external electronic device. The electronic device may determine that the external electronic device is in the MDE, when there is a device, which is capable of operating as a listener device for the voice assistant service, from among other devices connected to the external electronic device. For example, the electronic device may determine whether there is a device, which is in the same location (or adjacent location, space, or place) as the external electronic device, from among devices registered in a user account. The electronic device may determine that the external electronic device is in the MDE, when there is a device, which is in the same location (or adjacent location, space, or place) as the external electronic device, from among devices registered in a user account. For example, the electronic device may determine whether the external electronic device and the device registered in the user account are in the same location (or adjacent location, space, or place) based on the location information and/or network connection information of the external electronic device and the location information and/or network connection information of the device registered in the user account.

According to an embodiment, in operation 1030, the electronic device may set an external electronic device not to be selected as a listener device based on the determination that the environment is the MDE. For example, the electronic device may exclude the external electronic device from competing to determine a listener device. For example, the electronic device may transmit information indicating that the environment is the MDE to an external electronic device, thereby preventing the external electronic device from participating in the competition for determining a listener device. For example, in response to receiving information indicating that the environment is the MDE, from the electronic device, the external electronic device may not participate in the competition for determining a listener device.

According to an embodiment, in operation 1040, the electronic device may select the external electronic device as a listener device based on the determination that the external electronic device is not in the MDE. For example, the electronic device may allow the external electronic device to operate as a listener device. For example, the electronic device may send, to an external electronic device, information indicating that the environment is not the MDE, thereby allowing the external electronic device to participate in the competition for determining a listener device. For example, in response to receiving information indicating that the environment is the MDE, from the electronic device, the external electronic device may participate in the competition for determining a listener device. For example, the external electronic device may be determined as a listener device through the competition. For example, the electronic device (determined as a listener device) may receive information corresponding to a user utterance received from the external electronic device, may process the user utterance, and may determine an action corresponding to the user utterance. The electronic device may determine an execution device that will perform an action corresponding to a user utterance, and may transmit a command to the execution device for performing the action corresponding to the user utterance.

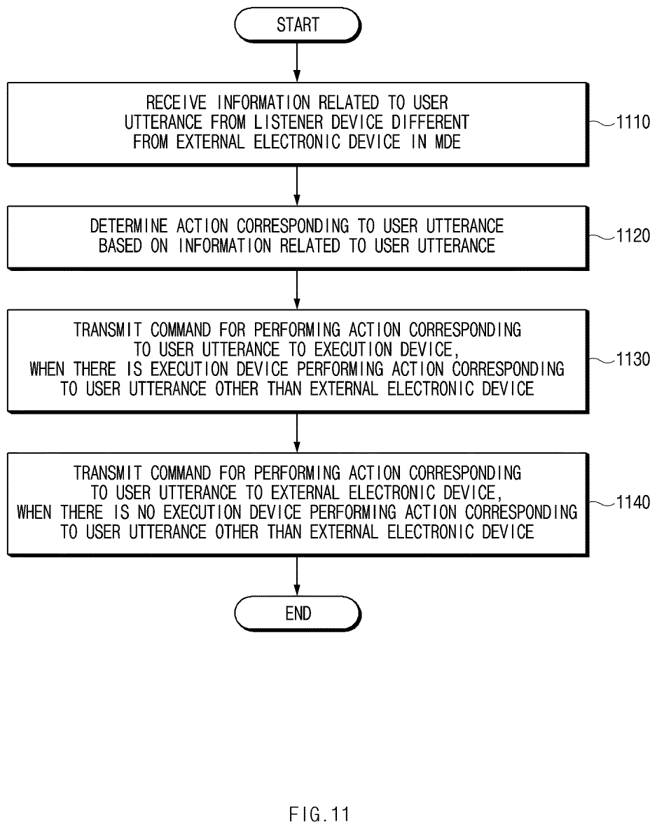

According to various embodiments, at least some of the operations of FIG. 10 may be omitted, or other operations (e.g., at least some of the operations in FIG. 11) may be added, and the order of at least some of the operations of FIG. 10 may be changed.

According to an embodiment of the disclosure, in providing a voice assistant service in an MDE, when a specific electronic device is playing content, the voice assistant service may be provided while content playback is maintained, by determining a listener device and/or an execution device associated with the voice assistant service, excluding the electronic device playing the content.

FIG. 11 is a flowchart of a user utterance processing method of an electronic device, according to an embodiment. For example, FIG. 11 may be an operation after the external electronic device in FIG. 10 is configured not to be selected as a listener device.

According to an embodiment, in operation 1110, an electronic device (e.g., a server device (e.g., the server device 150 of FIG. 1, the server device 300 of FIG. 3, the server 890 of FIG. 8, the server 1208 of FIG. 12, the intelligent server 1400 of FIGS. 13 to 15, or the service server 1500)) may receive information related to a user utterance from a listener device (e.g., the second device 130 of FIG. 1 or the second electronic device 520, 620, or 720 of FIGS. 5 to 7) different from an external electronic device (e.g., the first device 110 of FIG. 1, the electronic device 200 of FIG. 2, the first electronic device 400, 510, 610, or 710 of FIGS. 4 to 7, or the first electronic device 870 of FIG. 8) in an MDE. The information related to a user utterance may include a user utterance, data obtained by recognizing the user utterance, data obtained by converting the user utterance, and/or data obtained by performing natural language processing on the user utterance. According to an embodiment, the external electronic device may be playing content. For example, the external electronic device may not be selected as a listener device in MDE because it is playing the content.

According to an embodiment, in operation 1120, the electronic device may determine the action corresponding to the user utterance based on the information related to the user utterance.

According to an embodiment, in operation 1130, the electronic device may transmit a command for performing the action corresponding to the user utterance to the execution device, when there is an execution device performing the action corresponding to the user utterance other than the external electronic device. For example, the electronic device may determine an execution device other than the external electronic device and may perform an action corresponding to a user utterance, thereby allowing the external electronic device to maintain playback of the content.

According to an embodiment, in operation 1140, the electronic device may transmit a command for performing the action corresponding to the user utterance to the external electronic device, when there is no execution device performing the action corresponding to the user utterance other than the external electronic device. For example, the electronic device may determine an external electronic device as an execution device that performs an action corresponding to a user utterance. For example, the external electronic device may perform the action corresponding to the user utterance, thereby at least temporarily stopping playback of content. According to an embodiment, even though there is an execution device, other than the external electronic device, which performs an action corresponding to a user utterance, when an operation of the external electronic device is requested (e.g., when the external electronic device is specified by the user utterance, or when the action corresponding to the user utterance is an action of playing the same type of content as content currently being played by the external electronic device (e.g., when it is an action of changing the content currently being played)), the electronic device may transmit a command for performing the action corresponding to the user utterance to the external electronic device.

According to various embodiments, at least some of the operations of FIG. 11 may be omitted, or other operations (e.g., at least some of the operations in FIG. 10) may be added, and the order of at least some of the operations of FIG. 11 may be changed. According to various embodiments, in a voice assistant system including an electronic device and a server, at least some of the operations of FIGS. 9 to 11 may be performed in conjunction with each other, and at least some of the operations of FIGS. 9 to 11 may be omitted or performed in a changed order.

According to an embodiment of the disclosure, in providing a voice assistant service in an MDE, when a specific electronic device is playing content, the voice assistant service may be provided while content playback is maintained, by determining a listener device and/or an execution device associated with the voice assistant service, excluding the electronic device playing the content.

According to an embodiment a user utterance processing method of an electronic device may include receiving a user utterance, recognizing whether content is being played when receiving a user utterance, recognizing whether there is at least one first external electronic device connected to the electronic device when the content is being played, determining whether an environment is an MDE related to a voice assistant service, based on at least part of information of the at least one first external electronic device connected to the electronic device and/or information of at least one second external electronic device registered in a user account, configuring the electronic device not to be selected as a listener device receiving a user utterance in the MDE based on a determination that the environment is the MDE, and receiving a user utterance as the listener device based on a determination that the environment is not the MDE.

According to an embodiment, the method may further include maintaining playback of the content based on the determination that the environment is the MDE.

According to an embodiment, the determining of whether the environment is the MDE may include determining that the environment is the MDE, based on information of the at least one first external electronic device when at least one external electronic device capable of operating as the listener device among the at least one first external electronic device is included.

According to an embodiment, the determining of whether the environment is the MDE may include transmitting information of the at least one first external electronic device to at least one external server associated with the voice assistant service, and receiving information indicating whether the environment is the MDE, from the at least one external server based at least partly on the information of the at least one first external electronic device.

According to an embodiment, the determining of whether the environment is the MDE may include determining whether at least one external electronic device capable of operating as the listener device among the at least one second external electronic device is located at a location the same as the electronic device, and determining that the environment is the MDE when there is at least one external electronic device located in the location the same as the electronic device.

According to an embodiment, the determining of whether the at least one external electronic device is located at the same location may include determining whether at least one external electronic device capable of operating as the listener device among the at least one second external electronic device is located at the location the same as the electronic device based on at least some of location information and network connection information of the at least one second external electronic device and at least some of location information and network connection information of the electronic device.

According to an embodiment, the configuring of the electronic device not to be selected as the listener device may include configuring the electronic device to be excluded from competition for determining the listener device from among a plurality of electronic devices, which are included in the MDE, in the MDE.

According to an embodiment, the method may further include configuring the electronic device to participate in the competition when playback of the content ends after configuring the electronic device to be excluded from the competition.

FIG. 12 is a block diagram illustrating an electronic device 1201 in a network environment 1200 according to various embodiments. Referring to FIG. 12, the electronic device 1201 in the network environment 1200 may communicate with an electronic device 1202 via a first network 1298 (e.g., a short-range wireless communication network), or at least one of an electronic device 1204 or a server 1208 via a second network 1299 (e.g., a long-range wireless communication network). According to an embodiment, the electronic device 1201 may communicate with the electronic device 1204 via the server 1208. According to an embodiment, the electronic device 1201 may include a processor 1220, memory 1230, an input module 1250, a sound output module 1255, a display module 1260, an audio module 1270, a sensor module 1276, an interface 1277, a connecting terminal 1278, a haptic module 1279, a camera module 1280, a power management module 1288, a battery 1289, a communication module 1290, a subscriber identification module(SIM) 1296, or an antenna module 1297. In some embodiments, at least one of the components (e.g., the connecting terminal 1278) may be omitted from the electronic device 1201, or one or more other components may be added in the electronic device 1201. In some embodiments, some of the components (e.g., the sensor module 1276, the camera module 1280, or the antenna module 1297) may be implemented as a single component (e.g., the display module 1260).

The processor 1220 may execute, for example, software (e.g., a program 1240) to control at least one other component (e.g., a hardware or software component) of the electronic device 1201 coupled with the processor 1220, and may perform various data processing or computation. According to one embodiment, as at least part of the data processing or computation, the processor 1220 may store a command or data received from another component (e.g., the sensor module 1276 or the communication module 1290) in volatile memory 1232, process the command or the data stored in the volatile memory 1232, and store resulting data in non-volatile memory 1234. According to an embodiment, the processor 1220 may include a main processor 1221 (e.g., a central processing unit (CPU) or an application processor (AP)), or an auxiliary processor 1223 (e.g., a graphics processing unit (GPU), a neural processing unit (NPU), an image signal processor (ISP), a sensor hub processor, or a communication processor (CP)) that is operable independently from, or in conjunction with, the main processor 1221. For example, when the electronic device 1201 includes the main processor 1221 and the auxiliary processor 1223, the auxiliary processor 1223 may be adapted to consume less power than the main processor 1221, or to be specific to a specified function. The auxiliary processor 1223 may be implemented as separate from, or as part of the main processor 1221.

The auxiliary processor 1223 may control at least some of functions or states related to at least one component (e.g., the display module 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). According to an embodiment, the auxiliary processor 1223 (e.g., an image signal processor or a communication processor) may be implemented as part of another component (e.g., the camera module 1280 or the communication module 1290) functionally related to the auxiliary processor 1223. According to an embodiment, the auxiliary processor 1223 (e.g., the neural processing unit) may include a hardware structure specified for artificial intelligence model processing. An artificial intelligence model may be generated by machine learning. Such learning may be performed, e.g., by the electronic device 1201 where the artificial intelligence is performed or via a separate server (e.g., the server 1208). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input module 1250 may receive a command or data to be used by another component (e.g., the processor 1220) of the electronic device 1201, from the outside (e.g., a user) of the electronic device 1201. The input module 1250 may include, for example, a microphone, a mouse, a keyboard, a key (e.g., a button), or a digital pen (e.g., a stylus pen).

The sound output module 1255 may output sound signals to the outside of the electronic device 1201. The sound output module 1255 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1260 may visually provide information to the outside (e.g., a user) of the electronic device 1201. The display module 1260 may include, for example, a display, a hologram device, or a projector and control circuitry to control a corresponding one of the display, hologram device, and projector. According to an embodiment, the display module 1260 may include a touch sensor adapted to detect a touch, or a pressure sensor adapted to measure the intensity of force incurred by the touch.

The audio module 1270 may convert a sound into an electrical signal and vice versa. According to an embodiment, the audio module 1270 may obtain the sound via the input module 1250, or output the sound via the sound output module 1255 or a headphone of an external electronic device (e.g., an electronic device 1202) directly (e.g., wiredly) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. According to an embodiment, the sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device (e.g., the electronic device 1202) directly (e.g., wiredly) or wirelessly. According to an embodiment, the interface 1277 may include, for example, a high definition multimedia interface (HDMI), a universal serial bus (USB) interface, a secure digital (SD) card interface, or an audio interface.

A connecting terminal 1278 may include a connector via which the electronic device 1201 may be physically connected with the external electronic device (e.g., the electronic device 1202). According to an embodiment, the connecting terminal 1278 may include, for example, a HDMI connector, a USB connector, a SD card connector, or an audio connector (e.g., a headphone connector).

The haptic module 1279 may convert an electrical signal into a mechanical stimulus (e.g., a vibration or a movement) or electrical stimulus which may be recognized by a user via his tactile sensation or kinesthetic sensation. According to an embodiment, the haptic module 1279 may include, for example, a motor, a piezoelectric element, or an electric stimulator.

The camera module 1280 may capture a still image or moving images. According to an embodiment, the camera module 1280 may include one or more lenses, image sensors, image signal processors, or flashes.

The power management module 1288 may manage power supplied to the electronic device 1201. According to one embodiment, the power management module 1288 may be implemented as at least part of, for example, a power management integrated circuit (PMIC).

The battery 1289 may supply power to at least one component of the electronic device 1201. According to an embodiment, the battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the application processor (AP)) and supports a direct (e.g., wired) communication or a wireless communication. According to an embodiment, the communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as BluetoothTM, wireless-fidelity (Wi-Fi) direct, or infrared data association (IrDA)) or the second network 1299 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The wireless communication module 1292 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1292 may support a high-frequency band (e.g., the mmWave band) to achieve, e.g., a high data transmission rate. The wireless communication module 1292 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1292 may support various requirements specified in the electronic device 1201, an external electronic device (e.g., the electronic device 1204), or a network system (e.g., the second network 1299). According to an embodiment, the wireless communication module 1292 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1297 may transmit or receive a signal or power to or from the outside (e.g., the external electronic device) of the electronic device 1201. According to an embodiment, the antenna module 1297 may include an antenna including a radiating element composed of a conductive material or a conductive pattern formed in or on a substrate (e.g., a printed circuit board (PCB)). According to an embodiment, the antenna module 1297 may include a plurality of antennas (e.g., array antennas). In such a case, at least one antenna appropriate for a communication scheme used in the communication network, such as the first network 1298 or the second network 1299, may be selected, for example, by the communication module 1290 (e.g., the wireless communication module 1292) from the plurality of antennas. The signal or the power may then be transmitted or received between the communication module 1290 and the external electronic device via the selected at least one antenna. According to an embodiment, another component (e.g., a radio frequency integrated circuit (RFIC)) other than the radiating element may be additionally formed as part of the antenna module 1297.

According to various embodiments, the antenna module 1297 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-English peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1201 and the external electronic device 1204 via the server 1208 coupled with the second network 1299. Each of the electronic devices 1202 or 1204 may be a device of a same type as, or a different type, from the electronic device 1201. According to an embodiment, all or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1201. The electronic device 1201 may provide the outcome, with or without further processing of the outcome, as at least part of a reply to the request. To that end, a cloud computing, distributed computing, mobile edge computing (MEC), or client-server computing technology may be used, for example. The electronic device 1201 may provide ultra low-latency services using, e.g., distributed computing or mobile edge computing. In another embodiment, the external electronic device 1204 may include an internet-of-things (IOT) device. The server 1208 may be an intelligent server using machine learning and/or a neural network. According to an embodiment, the external electronic device 1204 or the server 1208 may be included in the second network 1299. The electronic device 1201 may be applied to intelligent services (e.g., smart home, smart city, smart car, or healthcare) based on 5G communication technology or IoT-related technology.

FIG. 13 is a block diagram illustrating an integrated intelligence system, according to an embodiment.

Referring to FIG. 13, an integrated intelligence system according to an embodiment may include a user terminal 1301, an intelligence server 1400, and a service server 1500.

The user terminal 1301 according to an embodiment may be a terminal device (or an electronic device) capable of connecting to Internet, and may be, for example, a mobile phone, a smartphone, a personal digital assistant (PDA), a notebook computer, a television (TV), a household appliance, a wearable device, a head mounted display (HMD), or a smart speaker.

According to the illustrated embodiment, the user terminal 1301 may include a communication interface 1390, a microphone 1370, a speaker 1355, a display 1360, a memory 1330, or a processor 1320. The listed components may be operatively or electrically connected to one another.

The communication interface 1390 according to an embodiment may be connected to an external device and may be configured to transmit or receive data to or from the external device. The microphone 1370 according to an embodiment may receive a sound (e.g., a user utterance) to convert the sound into an electrical signal. The speaker 1355 according to an embodiment may output the electrical signal as sound (e.g., voice). The display 1360 according to an embodiment may be configured to display an image or a video. The display 1360 according to an embodiment may display the graphic user interface (GUI) of the running app (or an application program).

The memory 1330 according to an embodiment may store a client module 1331, a software development kit (SDK) 1333, and a plurality of apps 1435. The client module 1331 and the SDK 1333 may constitute a framework (or a solution program) for performing general-purposed functions. Furthermore, the client module 1331 or the SDK 1333 may constitute the framework for processing a voice input.

The plurality of apps 1335 may be programs for performing a specified function. According to an embodiment, the plurality of apps 1335 may include a first app 1335a and/or a second app 1335_3. According to an embodiment, each of the plurality of apps 1335 may include a plurality of actions for performing a specified function. For example, the apps may include an alarm app, a message app, and/or a schedule app. According to an embodiment, the plurality of apps 1335 may be executed by the processor 1320 to sequentially execute at least part of the plurality of actions.

According to an embodiment, the processor 1320 may control overall operations of the user terminal 1301. For example, the processor 1320 may be electrically connected to the communication interface 1390, the microphone 1370, the speaker 1355, and the display 1360 to perform a specified operation. For example, the processor 1320 may include at least one processor.

Moreover, the processor 1320 according to an embodiment may execute the program stored in the memory 1330 so as to perform a specified function. For example, according to an embodiment, the processor 1320 may execute at least one of the client module 1331 or the SDK 1333 so as to perform a following operation for processing a voice input. The processor 1320 may control operations of the plurality of apps 1335 via the SDK 1333. The following actions described as the actions of the client module 1331 or the SDK 1333 may be the actions performed by the execution of the processor 1320.

According to an embodiment, the client module 1331 may receive a voice input. For example, the client module 1331 may receive a voice signal corresponding to a user utterance detected through the microphone 1370. The client module 1331 may transmit the received voice input (e.g., a voice input) to the intelligence server 1400. The client module 1331 may transmit state information of the user terminal 1301 to the intelligence server 1400 together with the received voice input. For example, the state information may be execution state information of an app.

According to an embodiment, the client module 1331 may receive a result corresponding to the received voice input. For example, when the intelligence server 1400 is capable of calculating the result corresponding to the received voice input, the client module 1331 may receive the result corresponding to the received voice input. The client module 1331 may display the received result on the display 1360.

According to an embodiment, the client module 1331 may receive a plan corresponding to the received voice input. The client module 1331 may display, on the display 1360, a result of executing a plurality of actions of an app depending on the plan. For example, the client module 1331 may sequentially display the result of executing the plurality of actions on a display. For another example, the user terminal 1301 may display only a part of results (e.g., a result of the last action) of executing the plurality of actions, on the display.

According to an embodiment, the client module 1331 may receive a request for obtaining information necessary to calculate the result corresponding to a voice input, from the intelligence server 1400. According to an embodiment, the client module 1331 may transmit the necessary information to the intelligence server 1400 in response to the request.

According to an embodiment, the client module 1331 may transmit, to the intelligence server 1400, information about the result of executing a plurality of actions depending on the plan. The intelligence server 1400 may identify that the received voice input is correctly processed, using the result information.

According to an embodiment, the client module 1331 may include a speech recognition module. According to an embodiment, the client module 1331 may recognize a voice input for performing a limited function, via the speech recognition module. For example, the client module 1331 may launch an intelligence app for processing a specific voice input by performing an organic action, in response to a specified voice input (e.g., wake up!).

According to an embodiment, the intelligence server 1400 may receive information associated with a user's voice input from the user terminal 1301 over a communication network 1399. According to an embodiment, the intelligence server 1400 may convert data associated with the received voice input to text data. According to an embodiment, the intelligence server 1400 may generate at least one plan for performing a task corresponding to the user's voice input, based on the text data.

According to an embodiment, the plan may be generated by an artificial intelligent (AI) system. The AI system may be a rule-based system, or may be a neural network-based system (e.g., a feedforward neural network (FNN) and/or a recurrent neural network (RNN)). Alternatively, the AI system may be a combination of the above-described systems or an AI system different from the above-described system. According to an embodiment, the plan may be selected from a set of predefined plans or may be generated in real time in response to a user's request. For example, the AI system may select at least one plan of the plurality of predefined plans.

According to an embodiment, the intelligence server 1400 may transmit a result according to the generated plan to the user terminal 1301 or may transmit the generated plan to the user terminal 1301. According to an embodiment, the user terminal 1301 may display the result according to the plan, on a display. According to an embodiment, the user terminal 1301 may display a result of executing the action according to the plan, on the display.

The intelligence server 1400 according to an embodiment may include a front end 1410, a natural language platform 1420, a capsule database 1430, an execution engine 1440, an end user interface 1450, a management platform 1460, a big data platform 1470, or an analytic platform 1480.

According to an embodiment, the front end 1410 may receive a voice input received from the user terminal 1301. The front end 1410 may transmit a response corresponding to the voice input to the user terminal 1301.

According to an embodiment, the natural language platform 1420 may include an automatic speech recognition (ASR) module 1421, a natural language understanding (NLU) module 1423, a planner module 1425, a natural language generator (NLG) module 1427, and/or a text to speech module (TTS) module 1429.

According to an embodiment, the ASR module 1421 may convert the voice input received from the user terminal 1301 into text data. According to an embodiment, the NLU module 1423 may grasp the intent of the user, using the text data of the voice input. For example, the NLU module 1423 may grasp the intent of the user by performing syntactic analysis or semantic analysis. According to an embodiment, the NLU module 1423 may grasp the meaning of words extracted from the voice input by using linguistic features (e.g., syntactic elements) such as morphemes or phrases and may determine the intent of the user by matching the grasped meaning of the words to the intent.

According to an embodiment, the planner module 1425 may generate the plan by using a parameter and the intent that is determined by the NLU module 1423. According to an embodiment, the planner module 1425 may determine a plurality of domains necessary to perform a task, based on the determined intent. The planner module 1425 may determine a plurality of actions included in each of the plurality of domains determined based on the intent. According to an embodiment, the planner module 1425 may determine the parameter necessary to perform the determined plurality of actions or a result value output by the execution of the plurality of actions. The parameter and the result value may be defined as a concept of a specified form (or class). As such, the plan may include the plurality of actions and/or a plurality of concepts, which are determined by the intent of the user. The planner module 1425 may determine the relationship between the plurality of actions and the plurality of concepts stepwise (or hierarchically). For example, the planner module 1425 may determine the execution sequence of the plurality of actions, which are determined based on the user's intent, based on the plurality of concepts. In other words, the planner module 1425 may determine an execution sequence of the plurality of actions, based on the parameters necessary to perform the plurality of actions and the result output by the execution of the plurality of actions. Accordingly, the planner module 1425 may generate a plan including information (e.g., ontology) about the relationship between the plurality of actions and the plurality of concepts. The planner module 1425 may generate the plan, using information stored in the capsule DB 1430 storing a set of relationships between concepts and actions.

According to an embodiment, the NLG module 1427 may change specified information into information in a text form. The information changed to the text form may be in the form of a natural language speech. The TTS module 1429 according to an embodiment may change information in the text form to information in a voice form.

According to an embodiment, all or part of the functions of the natural language platform 1420 may be also implemented in the user terminal 1301.

The capsule DB 1430 may store information about the relationship between the actions and the plurality of concepts corresponding to a plurality of domains. According to an embodiment, the capsule may include a plurality of action objects (or action information) and concept objects (or concept information) included in the plan. According to an embodiment, the capsule DB 1430 may store the plurality of capsules in a form of a concept action network (CAN). According to an embodiment, the plurality of capsules may be stored in the function registry included in the capsule DB 1430.

The capsule DB 1430 may include a strategy registry that stores strategy information necessary to determine a plan corresponding to a voice input. When there are a plurality of plans corresponding to the voice input, the strategy information may include reference information for determining one plan. According to an embodiment, the capsule DB 1430 may include a follow-up registry that stores information of the follow-up action for suggesting a follow-up action to the user in a specified context. For example, the follow-up action may include a follow-up utterance. According to an embodiment, the capsule DB 1430 may include a layout registry storing layout information of information output via the user terminal 1301. According to an embodiment, the capsule DB 1430 may include a vocabulary registry storing vocabulary information included in capsule information. According to an embodiment, the capsule DB 1430 may include a dialog registry storing information about dialog (or interaction) with the user. The capsule DB 1430 may update an object stored via a developer tool. For example, the developer tool may include a function editor for updating an action object or a concept object. The developer tool may include a vocabulary editor for updating a vocabulary. The developer tool may include a strategy editor that generates and registers a strategy for determining the plan. The developer tool may include a dialog editor that creates a dialog with the user. The developer tool may include a follow-up editor capable of activating a follow-up target and editing the follow-up utterance for providing a hint. The follow-up target may be determined based on a target, the user's preference, or an environment condition, which is currently set. The capsule DB 1430 according to an embodiment may be also implemented in the user terminal 1301.

According to an embodiment, the execution engine 1440 may calculate a result by using the generated plan. The end user interface 1450 may transmit the calculated result to the user terminal 1301. Accordingly, the user terminal 1301 may receive the result and may provide the user with the received result. According to an embodiment, the management platform 1460 may manage information used by the intelligence server 1400. According to an embodiment, the big data platform 1470 may collect data of the user. According to an embodiment, the analytic platform 1480 may manage quality of service (QOS) of the intelligence server 1400. For example, the analytic platform 1480 may manage the component and processing speed (or efficiency) of the intelligence server 1400.

According to an embodiment, the service server 1500 may provide the user terminal 1301 with a specified service (e.g., ordering food or booking a hotel). According to an embodiment, the service server 1500 may be a server operated by the third party. According to an embodiment, the service server 1500 may provide the intelligence server 1400 with information for generating a plan corresponding to the received voice input. The provided information may be stored in the capsule DB 1430. Furthermore, the service server 1500 may provide the intelligence server 1400 with result information according to the plan.

In the above-described integrated intelligence system, the user terminal 1301 may provide the user with various intelligent services in response to a user input. The user input may include, for example, an input through a physical button, a touch input, or a voice input.

According to an embodiment, the user terminal 1301 may provide a speech recognition service via an intelligence app (or a speech recognition app) stored therein. In this case, for example, the user terminal 1301 may recognize a user utterance or a voice input, which is received via the microphone, and may provide the user with a service corresponding to the recognized voice input.

According to an embodiment, the user terminal 1301 may perform a specified action, based on the received voice input, independently, or together with the intelligence server 1400 and/or the service server 1500. For example, the user terminal 1301 may launch an app corresponding to the received voice input and may perform the specified action via the executed app.

According to an embodiment, when providing a service together with the intelligence server 1400 and/or the service server 1500, the user terminal 1301 may detect a user utterance by using the microphone 1370 and may generate a signal (or voice data) corresponding to the detected user utterance. The user terminal may transmit the voice data to the intelligence server 1400 by using the communication interface 1390.

According to an embodiment, the intelligence server 1400 may generate a plan for performing a task corresponding to the voice input or the result of performing an action depending on the plan, as a response to the voice input received from the user terminal 1301. For example, the plan may include a plurality of actions for performing the task corresponding to the voice input of the user and/or a plurality of concepts associated with the plurality of actions. The concept may define a parameter to be input upon executing the plurality of actions or a result value output by the execution of the plurality of actions. The plan may include relationship information between the plurality of actions and/or the plurality of concepts.

According to an embodiment, the user terminal 1301 may receive the response by using the communication interface 1390. The user terminal 1301 may output the voice signal generated in the user terminal 1301 to the outside by using the speaker 1355 or may output an image generated in the user terminal 1301 to the outside by using the display 1360.

In FIG. 13, it is described that speech recognition of a voice input received from the user terminal 1301, understanding and generating a natural language, and calculating a result by using a plan are performed on the intelligence server 1400. However, various embodiments of the disclosure are not limited thereto. For example, at least part of configurations (e.g., the natural language platform 1420, the execution engine 1440, and the capsule DB 1430) of the intelligence server 1400 may be embedded in the user terminal 1301 (or the electronic device 101 of FIG. 1), and the operation thereof may be performed by the user terminal 1301.

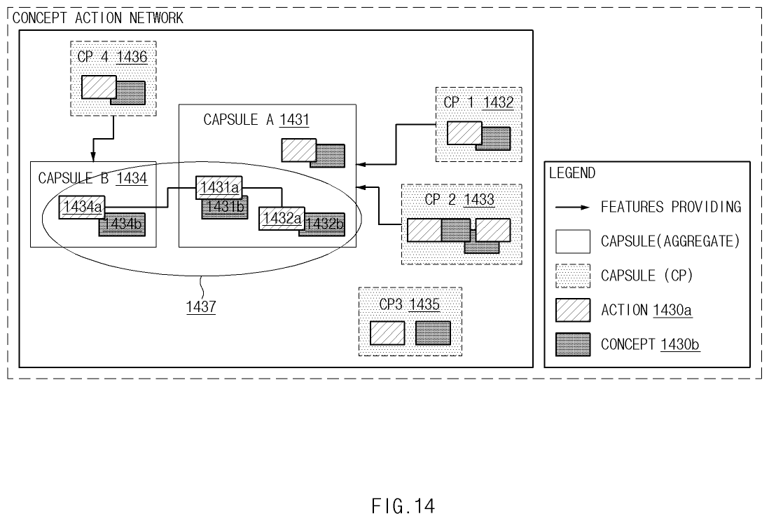

FIG. 14 is a diagram illustrating a form in which relationship information between a concept and an action is stored in a database, according to various embodiments.

A capsule database (e.g., the capsule DB 1430) of the intelligence server 1300 may store a capsule in the form of a CAN. The capsule DB may store an action for processing a task corresponding to a user's voice input and a parameter necessary for the action, in the CAN form.

The capsule DB may store a plurality capsules (a capsule A 1431 and a capsule B 1434) respectively corresponding to a plurality of domains (e.g., applications). According to an embodiment, a single capsule (e.g., the capsule A 1431) may correspond to a single domain (e.g., a location (geo) or an application). Furthermore, at least one service provider (e.g., CP 1 1432 or CP 13 1433) for performing a function for a domain associated with the capsule may correspond to one capsule. According to an embodiment, the single capsule may include at least one or more actions 1430a and at least one or more concepts 1430b for performing a specified function.

The natural language platform 1320 may generate a plan for performing a task corresponding to the received voice input, using the capsule stored in a capsule database. For example, the planner module 1325 of the natural language platform may generate the plan by using the capsule stored in the capsule database. For example, a plan 1437 may be generated by using actions 1431a and 1432a and concepts 1431b and 1432b of the capsule A 1430a and an action 1434a and a concept 1434b of the capsule B 1434.

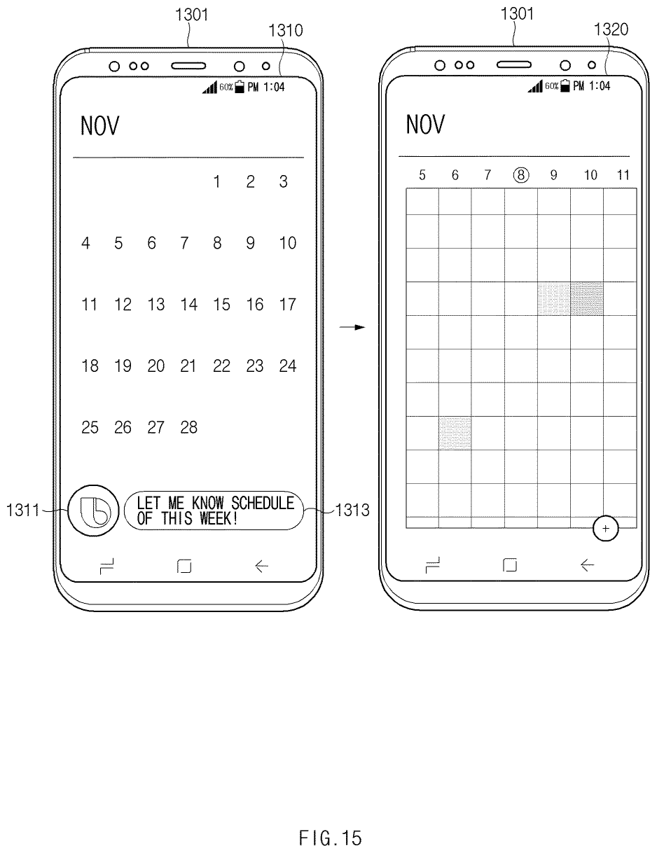

FIG. 15 is a view illustrating a screen in which a user terminal processes a voice input received through an intelligence app, according to various embodiments.

The user terminal 1301 may execute an intelligence app to process a user input through the intelligence server 1300.

According to an embodiment, on screen 1310, when recognizing a specified voice input (e.g., wake up!) or receiving an input via a hardware key (e.g., a dedicated hardware key), the user terminal 1301 may launch an intelligence app for processing a voice input. For example, the user terminal 1301 may launch the intelligence app in a state where a schedule app is executed. According to an embodiment, the user terminal 1301 may display an object (e.g., an icon) 1311 corresponding to the intelligence app, on the display 1440. According to an embodiment, the user terminal 1301 may receive a voice input by a user utterance. For example, the user terminal 1301 may receive a voice input saying that “let me know the schedule of this week!”. According to an embodiment, the user terminal 1301 may display a user interface (UI) 1313 (e.g., an input window) of the intelligence app, in which text data of the received voice input is displayed, on a display.

According to an embodiment, on screen 1315, the user terminal 1301 may display a result corresponding to the received voice input, on the display. For example, the user terminal 1301 may receive a plan corresponding to the received user input and may display ‘the schedule of this week’on the display depending on the plan.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1240) including one or more instructions that are stored in a storage medium (e.g., internal memory 1236 or external memory 1238) that is readable by a machine (e.g., the electronic device 1201). For example, a processor (e.g., the processor 1220) of the machine (e.g., the electronic device 1201) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a microphone;
a speaker;
a display;
a communication circuit;
a memory; and
a processor,
wherein the memory stores instructions, when executed by the processor, causing the electronic device to:
receive a user utterance through the microphone;
when receiving the user utterance, recognize whether content is being played through the display or the speaker;
when the content is being played, recognize whether there is at least one first external electronic device connected to the electronic device through the communication circuit;
determine whether an environment is a multi-device environment (MDE) related to a voice assistant service, based on at least part of information of the at least one first external electronic device connected to the electronic device and/or information of at least one second external electronic device registered in a user account;
configure the electronic device not to be selected as a listener device receiving a user utterance in the MDE based on a determination that the environment is the MDE; and
receive a user utterance as the listener device based on a determination that the environment is not the MDE.

2. The electronic device of claim 1, wherein the instructions, when executed by the processor, cause the electronic device to:
maintain playback of the content based on the determination that the environment is the MDE.

3. The electronic device of claim 1, wherein the instructions, when executed by the processor, cause the electronic device to:
determine that the environment is the MDE, based on information of the at least one first external electronic device when at least one external electronic device capable of operating as the listener device among the at least one first external electronic device is included.

4. The electronic device of claim 1, wherein the instructions, when executed by the processor, cause the electronic device to:
transmit information of the at least one first external electronic device to at least one external server associated with the voice assistant service; and
receive information indicating whether the environment is the MDE, from the at least one external server based at least partly on the information of the at least one first external electronic device.

5. The electronic device of claim 1, wherein the instructions, when executed by the processor, cause the electronic device to:
determine whether at least one external electronic device capable of operating as the listener device among the at least one second external electronic device is located at a location the same as the electronic device; and
determine that the environment is the MDE when there is at least one external electronic device located in the location the same as the electronic device.

6. The electronic device of claim 5, wherein the instructions, when executed by the processor, cause the electronic device to:
determine whether at least one external electronic device capable of operating as the listener device among the at least one second external electronic device is located at the location the same as the electronic device based on at least some of location information and network connection information of the at least one second external electronic device and at least some of location information and network connection information of the electronic device.

7. The electronic device of claim 5, wherein the instructions, when executed by the processor, cause the electronic device to:
send a request for determining whether the environment is the MDE, to at least one external server associated with the voice assistant service; and
receive information indicating whether the environment is the MDE, from the at least one external server based on whether at least one external electronic device capable of operating as the listener device among the at least one second external electronic device is located in the location the same as the electronic device.

8. The electronic device of claim 1, wherein the instructions, when executed by the processor, cause the electronic device to:
in the MDE, configure the electronic device to be excluded from competition for determining the listener device from among a plurality of electronic devices included in the MDE.

9. The electronic device of claim 8, wherein the instructions, when executed by the processor, cause the electronic device to:
when playback of the content ends after configuring the electronic device to be excluded from the competition, configure the electronic device to participate in the competition.

10. A server device comprising:
a communication circuit;
a memory; and
a processor,
wherein the memory stores instructions, when executed by the processor, causing the server device to:
receive a request for not being selected as a listener device receiving a user utterance for a voice assistant service, from an external electronic device playing content;
determine whether the external electronic device is in an MDE associated with the voice assistant service;
configure the external electronic device not to be selected as the listener device based on a determination that the external electronic device is in the MDE; and
select the external electronic device as the listener device based on a determination that the external electronic device is not in the MDE.

11. The server device of claim 11, wherein the instructions, when executed by the processor, cause the server device to:
recognize at least one electronic device registered in a user account the same as the external electronic device;
determine whether there is an electronic device capable of operating as the listener device around the electronic device, based on at least some of location information and network connection information of the at least one electronic device and at least some of location information and network connection information of the external electronic device; and
determine that the external electronic device is in the MDE, based on a determination that there is the electronic device capable of operating as the listener device around the electronic device.

12. The server device of claim 11, wherein the instructions, when executed by the processor, cause the server device to:
receive information related to a user utterance from the listener device different from the external electronic device in the MDE;
determine an action corresponding to the user utterance based on the information related to the user utterance;
when there is an execution device performing the action corresponding to the user utterance other than the external electronic device, transmit a command for performing the action corresponding to the user utterance to the execution device; and
when there is no execution device performing the action corresponding to the user utterance other than the external electronic device, transmit a command for performing the action corresponding to the user utterance to the external electronic device.

13. A user utterance processing method of an electronic device, the method comprising:
receiving a user utterance;
when receiving the user utterance, recognizing whether content is being played;
when the content is being played, recognizing whether there is at least one first external electronic device connected to the electronic device;
determining whether an environment is an MDE related to a voice assistant service, based on at least part of information of the at least one first external electronic device connected to the electronic device and/or information of at least one second external electronic device registered in a user account;
configuring the electronic device not to be selected as a listener device receiving a user utterance in the MDE based on a determination that the environment is the MDE; and
receiving a user utterance as the listener device based on a determination that the environment is not the MDE.

14. The method of claim 13, further comprising:
maintaining playback of the content based on the determination that the environment is the MDE.

15. The method of claim 13, wherein the determining of whether the environment is the MDE includes at least one of:
determining that the environment is the MDE, based on information of the at least one first external electronic device when at least one external electronic device capable of operating as the listener device among the at least one first external electronic device is included;
transmitting information of the at least one first external electronic device to at least one external server associated with the voice assistant service, and receiving information indicating whether the environment is the MDE, from the at least one external server based at least partly on the information of the at least one first external electronic device; or
determining whether at least one external electronic device capable of operating as the listener device among the at least one second external electronic device is located at a location the same as the electronic device, and determining that the environment is the MDE when there is the at least one external electronic device located in the location the same as the electronic device.
